(19) United States
(12) Patent Application Publication
(10) Pub. No.: US 2003/0204637 A1
(43) Pub. Date: Oct. 30, 2003

(54) Method and apparatus for generating compilable application programs

(76) Inventor: Kai Ming Chong, Mei Foo (HK)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/104,592

(22) Filed: Mar. 22, 2002

(51) Int. Cl. G06F 15/163; G06F 9/00

(52) U.S. Cl. 709/310; 709/328

(57) ABSTRACT

A compilable application program generator (100) comprises a graphical user interface (150) with a document creator (155) and a process flow charter (160). Each document used in a business operation is recreated electronically with the document creator (155), and the process flow of each of the recreated documents in the business operation is modeled with the process flow charter (160). Recreating the documents includes providing user specifications (105) and document process flow specifications (120). The document creator (155) and the process flow charter (160) use the provided user specifications (105) and produce definitions that stored in the memory (170). Predetermined data processing definitions are subsequently used by a data processing program generator (175) to produce a compilable data processing program module (130). Similarly, a report program generator (185) produces a compilable report program module (135) using predetermined report definitions.

### FIELD OF THE INVENTION

The present invention relates to generating a compilable application program, and more particularly to automatically generating a substantial portion of a compilable application program from user requirements.

### BACKGROUND OF THE INVENTION

When a commercial entity decides to computerize its business operations, the conventional approach is to purchase a suitable off-the-shelf software application program, have a customized software application solution, or a tailor made software application solution. An off-the-shelf software application program is a ready to run system; a customized software application solution is where a ready made software application provides a framework and portions are customized to suit a user's requirements; and a tailor made software application solution is designed specifically to meet a user's requirements.

An off-the-shelf software application program is attractive due to its substantially lower costs than either of the other two options. However, the owner of a business would need to model his business to operate in accordance with the operational model on which the off-the-shelf software application program is based. This can be difficult, as the operational model of businesses differ considerably, even when businesses are operating in the same type of business. Differences can be attributed to differences in local business practices, historical practices, or even the business owner's preferences.

As off-the-shelf software application programs do not take such differences into account, a disadvantage of off-the-shelf software application programs is that they are rarely a preferred solution but more commonly, an affordable one, albeit with limitations.

Another disadvantage of off-the shelf software application programs is that the programs are made available only in run-time i.e. object code form. Consequently, after installing an off-the shelf software application program, the program cannot be amended. Typically, any amendments can only be made by the supplier of the off-the shelf software application program, if such service is at all available. This is both inconvenient and potentially costly. Of course, there is also the likelihood that the supplier of the product would not entertain any requests for amendments. Examples of off-the shelf software application programs include SunAccount by Systems Union Group PLC. of the UK, and AccPac by AccPac International Inc. of the USA.

The customized software application program is one where System Analyst(s) (SA)(s) use a package software application program which includes source code, and modifies portions of the custom software application program source code to accommodate requirements of the owner of a business. Typically, the claim is eighty-twenty i.e. eighty percent of the custom software application program is used as is, and twenty percent is modified. A disadvantage of the custom software application program is the cost of one or more SAs that are required to do the customization work. Another disadvantage is, while the documentation for the custom software is good, the documentation on the modified portions tends to be rather poor.

As the custom software application program is based on a logical data model, the resulting customized solution will, to some degree, require the owner of a business to adapt his business operations to the customized solution. Consequently, it's not uncommon for a user to have to male changes to his operational processes, and for staff to require training when implementing a new customized software application program. Hence, another disadvantage of using the custom software application program is the need for the owner of a business to adapt his business operations to use the new customized software application program, and the costs of training or re-training his staff. Examples of customized software application programs are products/systems that are provided by SAP of Germany, and J. D. Edwards of USA.

Turning now to the tailor made software application program, a primary disadvantage here is the high cost, which is the highest relative to the two earlier options. This is due to the specialist skills required for one or more SA(s), who work with the owner of a business to determine his requirements, design a logical data model, and then write a compilable application program for the user. This process is time consuming, and coupled with the costs of retaining the services of SA(s) results in the high cost. Of course, the resulting tailor made software application program fulfils the requirements of the owner of a business, as the design is based on the specific requirements of the owner of the business. A disadvantage of the tailor made software application program option is the time and cost required to develop the software application program. Another disadvantage of the tailor made software application program is the generally poor documentation that is provided. Electronic Data Systems (EDS) of USA is an example of a company that provides tailor made software application solutions.

With the customized and tailor made solution, when working with the owner of a business to determine his requirements, much depends on the skill and experience of the SA(s), with the SA(s) asking the right questions, and determining relationships between various data elements of the system required by the owner of a business. As this process is dependent on the experience and the methodology adopted by an SA, a disadvantage of this process is the tendency for human error, which can lead to inconsistencies in the completed system.

Another concern with the customized software application program and the tailor made option is system maintenance. When there is a change of the staff that designed the modified portions of the customized software application program, or staff that designed the tailor made solution, amendments and even maintenance of the system can be difficult. And, where a system typically employs more than one design team, these problems are compounded. In large part this is due to the lack of up-to-date User and Technical documents, the generation and maintenance of which is subject to individual SA discipline and practice. Hence, another disadvantage of the customized and tailor made software application program solutions is the difficulty in maintenance and enhancement of the system.

There are products, such as DBTOOLS by PAX Informatica Industrial Ltda. of Brazil, XUPPER by Ken System of Japan, and OBSYDIAN by Synon Inc. of the USA, which are known as source code generators that are used as tools by SA(s) to reduce the amount of source code that has to be written when developing a customized or tailor made software application program. However, such code generators typically rely on the data model designed by the SA(s), and produces a skeletal framework of source code, leaving the SA(s) to write significant portions of the source code. As the data model is a logical presentation of data, such code generators cannot process any user requirements that cannot be modeled, e.g. which often is the case in business operations, as such requirements are sometimes unknown when the system is being designed. In addition, the code generators are focused on data relationships and not processing procedures, which reflect a business owner's operational processes. Consequently, such code generators are not perceived by SA(s) to be of much assistance.

U.S. Pat. No. 6,257,774 by Stack et al. and assigned to Authorgenics Inc. of the USA, discloses a system for generating compilable application programs. The system has a graphical user interface for a user to define components of the desired compilable application program, assign databases to each of the components units, and define specifications of the databases. In addition, the system has a an inherent hierarchical structure in order to operate with a hierarchical expert system.

A disadvantage of this system is the need to for a user to identify the components, which is similar to the task of designing a data model of the compilable application program. This can be difficult and time consuming. In addition, the performance of the resultant compilable application program will vary dependent on the components that are identified. Consequently, the performance of resultant compilable programs is unlikely be consistent.

Another disadvantage of the Authorgenics system is the need for a hierarchical expert system, and the consequent need for the system to have a hierarchical structure, as this limits the structure within which a system can be defined. Such limits can make the definition difficult when particular user requirements are not anticipated and provided for by the system.

A further disadvantage of the Authorgenics system is the need for a user to define databases, as this requires the user to specify the requirements of the database. Hence, the user would need to design a system at least to the level of defining one or more databases, before the Authorgenics system can be employed.

### BRIEF SUMMARY OF THE INVENTION

The present invention seeks to provide a method and apparatus for generating compilable application programs, which overcomes or at least reduces the abovementioned problems of the prior art.

Accordingly, in one aspect, the present invention provides a compilable application program generator for generating a compilable application program for a business operation, and wherein the business operation utilizes a plurality of documents, wherein the compilable application program generator comprises:

a graphical user interface comprising a document creator for receiving document specifications of each of the plurality of documents and for providing document definitions;

a memory coupled to the graphical user interface for storing the document definitions, and for storing a plurality of compilable program templates; and

a data processing program generator coupled to the memory, the data processing program generator for retrieving a reference data processing compilable program template from the memory, for accessing the document definitions, for selectively retrieving at least some of the plurality of compilable program templates from the memory in accordance with the document definitions, and for incorporating the at least some of the plurality of compilable program templates into the reference data processing compilable program template to produce a compilable data processing program module.

In another aspect the present invention provides a method for generating a compilable application program for a business operation, and wherein the business operation utilizes a plurality of documents, the method comprising the steps of:

a) receiving user specifications for each of the plurality of documents;

b) processing the user specifications to produce a plurality of definitions; and

c) using predetermined data processing definitions of the plurality of definitions and at least a first plurality of compilable program templates to generate a compilable data processing program module.

In yet another aspect the present invention provides a compilable report program generator for generating a compilable report program, wherein the compilable report program generator comprises:

a graphical user interface comprising a report composer for receiving report specifications of each of the plurality of reports and for providing report definitions;

a memory coupled to the graphical user interface for storing the report definitions, and for storing a plurality of compilable program templates; and

a report program generator coupled to the memory, the report program generator for retrieving a reference report compilable program template from the memory, for accessing the report definitions, for selectively retrieving at least some of the plurality of compilable program templates from the memory in accordance with the report definitions, and for incorporating the at least some of the plurality of compilable program templates into the reference report compilable program template to produce the compilable report program.

In still another aspect the present invention provides a method for generating a compilable report program, the method comprising the steps of:

a) receiving report specifications for each of a plurality of reports;

b) processing the report specifications to produce a plurality of report definitions; and

c) using the plurality of report definitions and at least a first plurality of compilable program templates to generate the compilable report program.

### BRIEF DESCRIPTION OF THE DRAWINGS

An embodiment of the present invention will now be more fully described, by way of example, with reference to the drawings of which:

FIG. 1 shows a functional block diagram of a compilable application program generator in accordance with the present invention;

FIG. 2 shows a functional block diagram of the memory of the compilable application program generator in FIG. 1;

FIG. 3 shows a flowchart detailing the operation of the compilable application program generator in FIG. 1; and

FIG. 4 shows a flowchart detailing the operation of the data processing program generator of the compilable application program generator in FIG. 1;

FIG. 5 shows a flowchart detailing the operation of the database definition language generator portion of the compilable application program generator in FIG. 1;

FIG. 6 shows a flowchart detailing the operation of the report program generator portion of the compilable application program generator in FIG. 1;

FIG. 7 shows a flowchart detailing the operation of the manual generator portion of the compilable application program generator in FIG. 1; and

FIGS. 8A-8AE show screen shots of the compilable application program generator in FIG. 1 when operating on a computer.

### DETAIL DESCRIPTION OF THE DRAWINGS

A compilable application program generator comprises a graphical user interface with a document creator and a process flow charter. Each document used in a business operation is recreated electronically with the document creator, and the process flow of each of the recreated documents in the business operation is modeled with the process flow charter. Recreating the documents includes providing user specifications such as data items, descriptions of the various data items, attributes of the data items and attributes of the documents. Process flow information, such as operations performed in relation to the data items of each of the documents, is also provided by user specifications when the process flow of each document is modeled using the process flow charter. The document creator and the process flow charter use the provided user specifications and produce definitions, which are subsequently used to produce compilable application programs. These definitions are selectively used by: a data processing program generator to generate a data processing program module; a database definition language generator for generating database definition language for a database that supports the data processing program; and a manual generator for generating manuals. The manual generator allows manuals, such as user and technical manuals for the compilable application program to be produced. In addition, the graphical user interface comprises a report composer, which receives the corresponding user specifications and provides report definitions, that are used by a report program generator for generating a report program module.

The compilable application program comprises the generated program source code modules i.e. the data processing program module and the report program module. In addition, the compilable application program generator produces the database definition language module and the manuals for the compilable application program. When a resulting executable application program is produced using the compilable application program, the resulting executable application program presents the recreated documents, and the recreated documents follow the same process flow as that in the business operations of the business. Hence, the owner of the business does not need to make substantive changes to his business processes to use a system produced by the compilable application program generator. In addition, as most of the compilable application program is generated automatically from predefined program templates, the time required to produce the generated compilable application program is substantially reduced. Further, due to the relative ease of use of the compilable application program generator, the required skill level is lower and the time when such skill is required is shorter. Hence, the cost for the owner of the business to develop or have developed a software application program that matches his requirements, is lower. Further, as the generated compilable application program is generated from the owner's existing business documents and business process flow, programming difficulties due to programming errors is reduced. In addition, as the graphical user interface effectively prompts for input in a methodical and uniform manner, hence the quality of the generated compilable application program is more consistent than the question and answer method adopted by SAs. Also, as the generated manuals are based on descriptions that are provided as the documents and processes are being entered by a programmer to the compilable application program generator, the resultant manuals are more thorough, organized, and standardized.

An advantage of the compilable application program generator is the ease with which user specifications to the graphical user interface can be changed and source code generated and regenerated and tested in a cyclic manner, until the generated compilable application program produces an executable application program, that substantially meets the requirements of the particular business operation.

Another advantage of the compilable application program generator is the provision for user specific requirements to be incorporated by allowing a programmer to include additional programmer written source code to the generated compilable application program. This allows additional functionality to be incorporated into the generated compilable application program, which remains intact during cyclic regeneration.

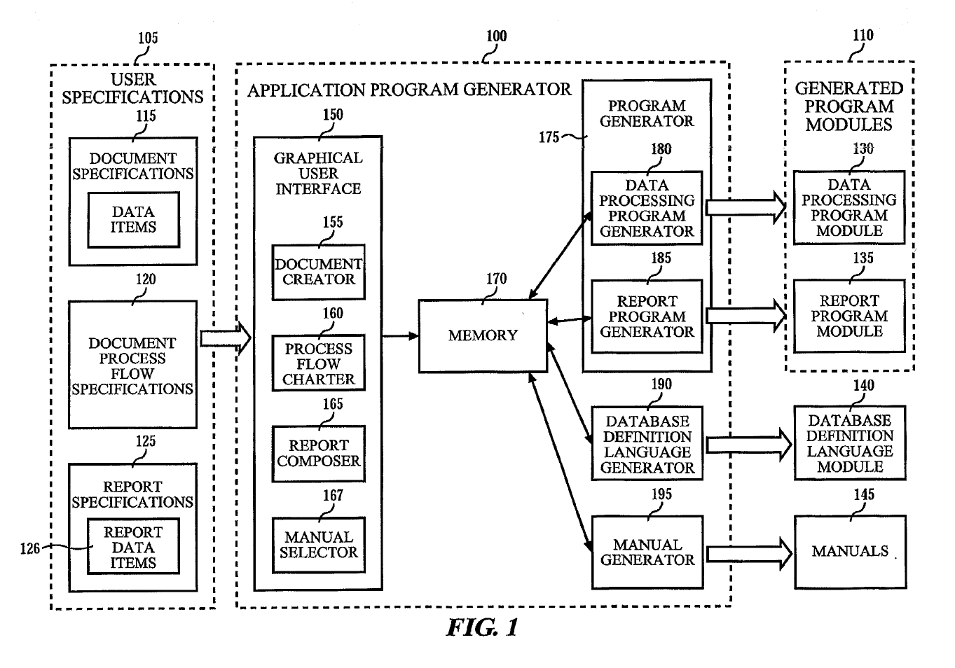

FIG. 1 shows a compilable application program generator 100 that receives user specifications 105 and produces generated program modules 110. In addition, the compilable application program generator 100 also produces a database definition language module 140, and manual(s) 145. The user specifications 105 comprises document specifications 115, document process flow specifications 120, and report specifications 125, and the generated program modules 110 comprises a data processing program module 130 and a report program module 135.

Typically, a business or administrative operation uses a number of documents, each document having document specifications 115 comprising a predetermined set of information or data items 116. Such documents can comprise paper or electronic forms, and each document has a predetermined process flow in the operation of the business or administration of an organization, and the process flow is defined by the document process flow specifications 120 associated with that document.

The document specifications 115 includes layout information indicating the arrangement of data items 116 of the document. The data items 116 include data fields, labels, reference fields, action indicators, buttons etc. A document can have a variety of document attributes, and a data item 116 can have a variety of data attributes. In addition, a programmer provides a description for each document, which describes the function of the document, and the programmer provides a description for each data item which, describes the function of that data item. As will be described later, these descriptions are used to generate manuals for the generated program modules 110 generated by the compilable application program generator 100.

The process flow specifications 120 is associated with each of the documents, and mirrors the manner in which each of the documents is processed in the operation of the business or administration of an organization. Typically, in a business operation, the process flow of a document comprises passing a document to a number of people in a predetermined sequence, where each person performs a predetermined action in relation to the document, and then passes the document on to the next person in the sequence. For example, a stock receipt is created, filled, approved and then posted to a stock ledger, after which it can be destroyed or archived. Hence, the process flow of a document can be expressed as having a status that changes after a service(s) is performed. In the example above, services can include creating, filling, or posting, and the process flow specifications 120 indicates the sequence of services and the status of the document 115 after each service. Reports are similar to documents in that report specifications 125 comprises layout data indicating the location of report data items 126 of the reports. The report data items 126 in turn have a variety of attributes.

The user specifications 105 are provided by a programmer to the compilable application program generator 100 via a graphical user interface 150 that is coupled to a memory 170. The graphical user interface 150 comprises a document creator 155, a process flow charter 160, a report composer 165, and a manual selector 167. In a preferred embodiment the graphical user interface 150 is a software program adapted to operate on a computer with a display, keyboard and pointing device, such as a mouse, the software program running on an operating system, such as Windows 98 by Microsoft Corporation of the USA, that supports such an interface. (The computer, display, keyboard, and mouse are not shown).

The document creator 155 is used to design or recreate the documents that are used in a business operation, similarly, the report composer 165 allows a user to design or recreate the reports 125 that are required. The process flow charter 160 is used to set out graphically, the status and services for each of the documents created by the document creator 155, and the manual selector 167 allows a programmer to select the manual(s) to be generated.

After document specifications 115, corresponding process flow specifications 120, and optionally, report specifications 125, are entered to the document creator 155, the process flow charter 160, and the report composer 165, respectively, the document creator 155, the process flow charter 160, and the report composer 165 produce a variety of definitions that are stored in the memory 170. A program generator 175 is coupled to the memory 170 for selectively accessing the definitions in the memory 170 and using selected definitions to generate each of the generated program modules 110.

The program generator 175 comprises a data processing program generator 180 for producing the data processing program module 130 and a report program generator 185 for producing the report program module 135. A database definition language generator 190 generates the database definition language module 140 for operating with the data processing program module 130, and a manual generator 195 generates the manual(s) 145 either in accordance with default selections or user specified selections provided by the manual selector 167.

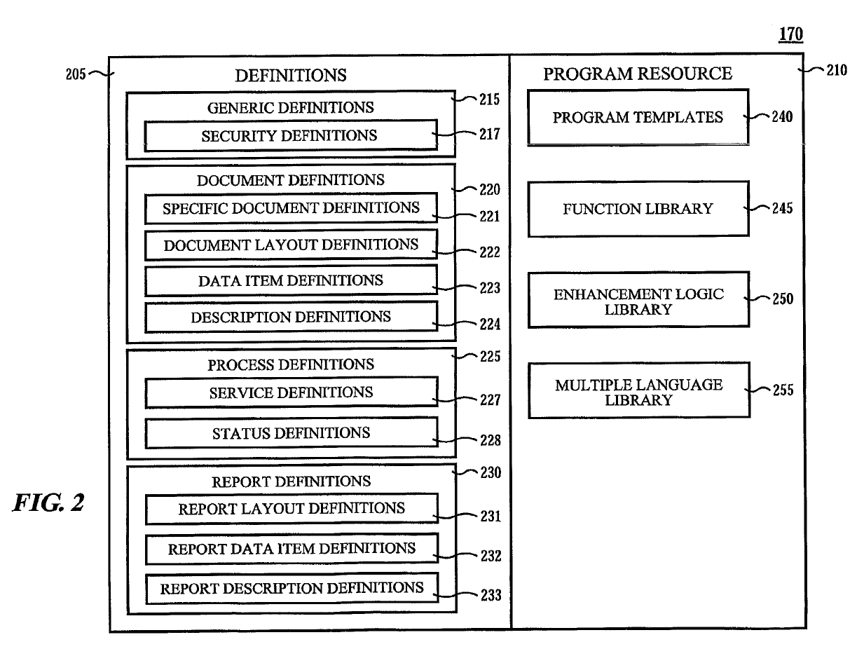

With reference to FIG. 2 the memory 170 comprises a definitions portion 205 and a program resource portion 210. The definitions portion 205 stores the definitions that are derived from programmer input of user specifications 105 through a variety of screens presented to the programmer via the graphical user interface 150. The program resource portion 210 stores predefined programming resources, which will be described in more detail later.

The definitions portion 205, includes: generic definitions 215, which for example comprises security definitions 217; document definitions 220 comprising specific document definitions 221, document layout definitions 222, data item definitions 223, and description definitions 224; process definitions 225 comprising service definitions 227 and status definitions 228; and report definitions 230 comprising report layout definitions 231, report data item definitions 232 and report description definitions 233.

Returning to the generic definitions 215, the security definitions 217 allow the programmer to define the security level required for a particular document, particular data field, particular program execution and/or particular service execution.

The specific document definitions 221 are derived from document attributes that are applicable to a particular document, and the programmer specifies the document attributes with some of the user specifications 105. Examples of document attributes include audit details to track changes to the documents, comments that provide a description of the document, and status bar generation, which specifies whether a status bar should be generated for a document, when the document is presented or displayed.

Document layout definitions 222 are derived from document layout attributes, where the programmer specifies the document layout attributes with some of the user specifications 105. The document layout attributes determine the arrangement of the data items 116, which include data fields, labels or captions, reference fields, etc. in a recreated document. Data definitions 223 are derived from attributes of the data items 116, which can include the length and decimal point specifications of a data item. The programmer specifies the attributes of the data items 116 with some of the user specifications 105. Description definitions 224 include comments that are provided by the programmer when specifying the document specifications 115 and when specifying the data items 116 of the documents, which are part of the user specifications 105.

The services definitions 227 and the status definitions 228 are derived from the attributes of services and status for each document, as specified by the document process flow specifications 120 and entered through the process flow charter 160. The attributes of services and status for each document as specified by the document process flow specifications 120 form part of the user specifications 105, as provided by the programmer.

The report layout definitions 231, the report data definitions 232 and the report description definitions 233 are derived from layout attributes of the reports, the attributes of the report data items 126, and the comments from the report specifications 125 and the comments from the report data items 126, respectively. Again, the layout attributes of the reports, the attributes of the report data items 126, and the comments from the report specifications 125 and the comments from the report data items 126, are specified by the programmer as part of the user specifications 105.

The program resource portion 210 stores program templates 240, a function library 245, an enhancement logic library 250 and a multiple language library 255. The program templates 240 comprise a set of files containing blocks of source code for performing predetermined operations. A number of these blocks of source code are combined in accordance with the definitions stored in the definitions portion 205 of the memory 170 to form a substantial portion of a generated compilable application program. The function library 245 holds a set of source code files that are reusable across multiple application programs. An example is a function to retrieve sales price, which is used in a variety of application programs. The enhancement logic library 250 stores one or more files of source code that can be used only for one particular application program. An example is a file that updates the inventory for a particular sales invoice. The multiple language library 255 contains one or more files with captions for the data fields in a document in a variety of languages, which are defined via the document creator 155. Corresponding languages are stored and referenced when the program generator 175 generates the generated program modules 110 of a generated compilable application program based on user language selection.

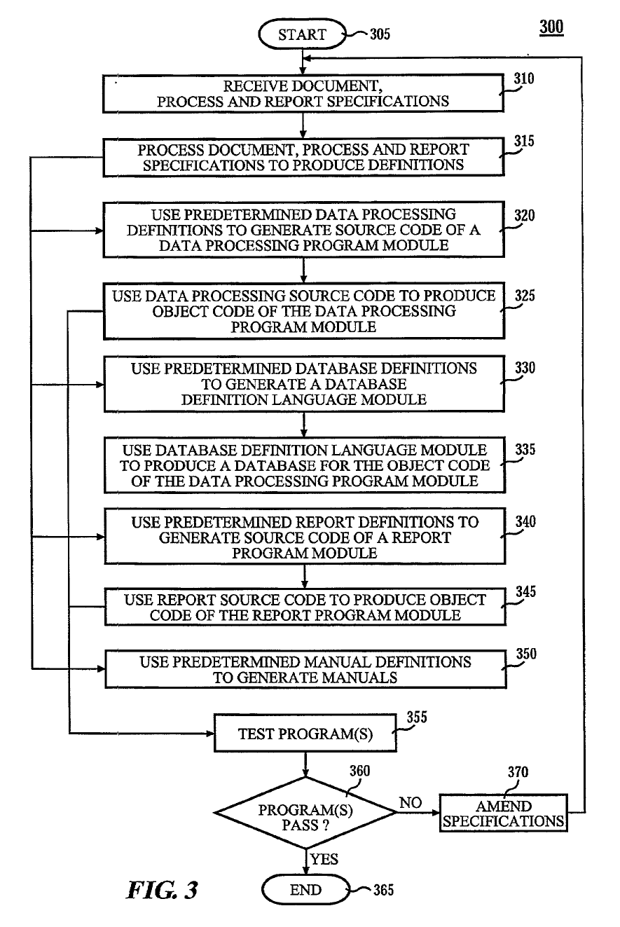

With reference now to FIG. 3, the operation 300 of the compilable application program generator 100 starts 305 with the graphical user interface 155 receiving 310 the document specifications 115, process flow specifications 120 and, optionally, the report specifications 125, from a programmer as some of the user specifications 105. The document specifications 115, process flow specifications 120 and report specifications 125 are processed 315 to produce definitions, which are stored in the definitions portion 205 of the memory 170. The processing of the specifications to produce the definitions can include a one to one relationship, where a particular user specification is simply stored as a particular definition.

The data processing program generator 180 uses predetermined data processing definitions from the definitions portion 205 of the memory 170 to generate 320 source code of the data processing program module 130, and the source code is then used to produce 325 object code of the data processing program module 130. The object code of the data processing program module 130 is then tested 355. When the data processing object code program passes 360 the test, the operation 300 ends 365. However, when the data processing object code program does not pass 360 the test, the relevant user specifications 105 can be amended 370, and this is accomplished by making changes to one or more of the user specifications 105 via the graphical user interface 150. The operation 300 then returns to step 310 of receiving the document specifications 115, process flow specifications 120 and, optionally, the report specifications 125, including the amended specifications, and the operation 300, then continues as described earlier. The step of amending the user specifications 105 may be repeated until the result of the step of testing 355 the program(s) is positive.

Similarly, the report program generator 185 uses predetermined report definitions from the definitions portion 205 of the memory 170 to generate 340 the source code for the report program module 135, and the source code is then used to produce 345 object code of the report program module 135. The object code of the report program module 135 is then tested 355. As before, when the object code of the report program module 135 passes 360 the test, the operation 300 ends 365. However, when the object code of the report program module 135 does not pass 360 the test, the relevant user specifications 105 can be amended 370, and this is accomplished by making changes to one or more of the user specifications 105 via the graphical user interface 150. The operation 300 then returns to step 310 of receiving the document specifications 115, process flow specifications 120 and, optionally, the report specifications 125, including the amended specifications, and the operation 300, then continues as described earlier. The step of amending the user specifications 105 may be repeated until the result of the step of testing 355 the program(s) is positive.

The database definition language generator 190 uses predetermined database definitions from the definitions portion 205 to generate 330 the database definition language module 140. The database definition language module 140 is then used to produce 335 a database for the object code program of the data processing program module 130. The database definition language can comprise data definition language (DDL), which can be interpreted by various database manipulation system (DBMS), such as Oracle, to create databases, database tables, fields, and objects.

In addition, the manual program generator 195 uses predetermined manual definitions from the definitions portion 205 of the memory 170 to generate 350 manuals 145 for the resultant executable/object code of the data processing program module 130 and the report program module 135.

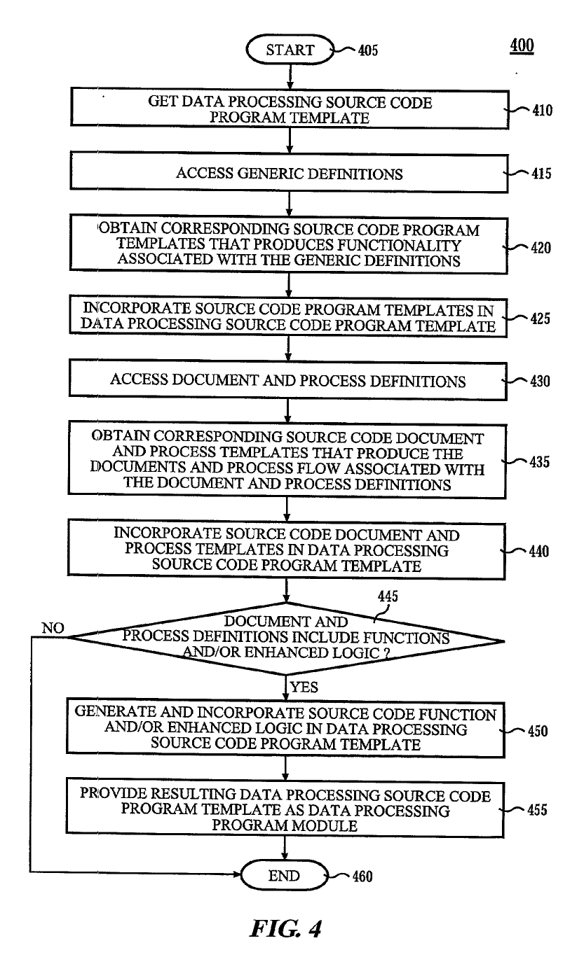

With further reference to FIG. 4, the operation 400 of the data processing program generator 180 starts 405 with the data processing program generator 180 getting 410 a data processing source code template for a compilable application program from the program templates 240 of the memory 170. The data processing program generator 180 then accesses 415 the generic definitions 215 stored in the definitions portion 205 of the memory 170, and obtains 420 corresponding source code program templates that produce functionality associated with the generic definitions 215 for the compilable application program to be generated. The data processing program generator 180 then incorporates 425 the source code program templates in the data processing source code program template.

Next, the data processing program generator 180 accesses 430 the document definitions 220 and the process definitions 225, and obtains 435 corresponding source code document and process templates that produce the documents and process flow associated with the document and process definitions 220 and 225. The data processing program generator 180 then incorporates 440 the source code document and process templates in the data processing source code program template.

A determination 445 is then made as to whether the documents and process definitions 220 and 225 include functions and/or enhanced logic, and when the determination 445 is negative, the operation 400 ends 460. Alternatively, when the determination 445 is positive, the data processing program generator 180 generates 450 and incorporates source code for functions and/or enhanced logic in the data processing source code program template. The data processing program generator 180, then provides 455 the resulting data processing source code program template as the data processing program module 130. The operation 400 then ends 460. The step of generating the source code for functions and/or enhanced logic includes obtaining programmer generated source code.

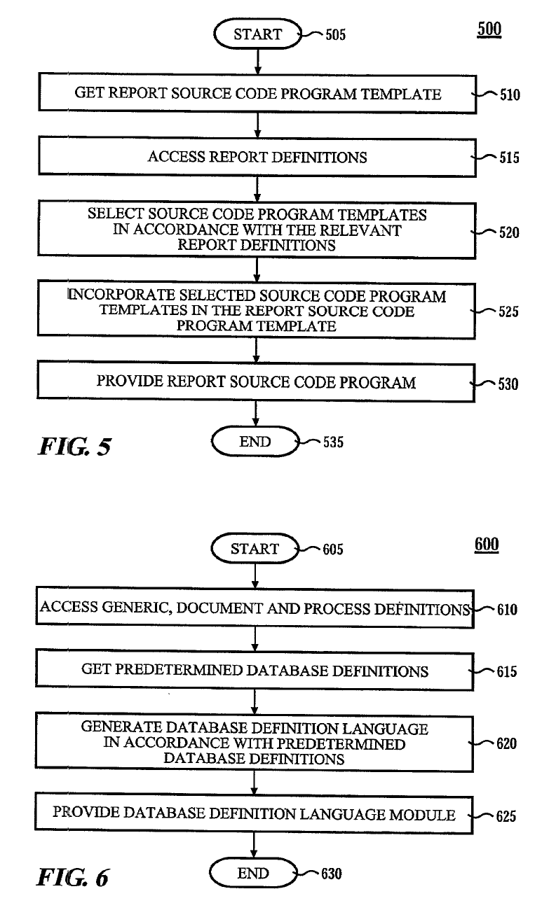

With reference to FIG. 5 the operation 500 of the report program generator 185 starts 505 with the report program generator 185 accessing the memory 170 to get 510 a report source code program template from the program templates 240. The report program generator 185 then accesses 515 the report definitions 230 stored in the definitions portion 205 of the memory 170, and selects 520 source code templates from the program templates 240, in accordance with the report definitions 230. Next the source code templates are incorporated 525 into the report source code program template to produce the resulting report source code program template. The report program generator 185 then provides the resulting report source code program template as the report program module 135, and the operation 500 ends 535. The report program module 140 creates a report for the generated programs in accordance with the report definitions 230.

With reference to FIG. 6 the operation 600 of the database definition language generator 190 starts 605 with the database definition language generator 190 accessing 610 the generic, document and process definitions 215, 220 and 225 in the memory 170 to get 615 predetermined database definitions. The predetermined database definitions are selected from the generic, document and process definitions 215, 220 and 225 in the memory 170. The database definition language generator 190 then generates 620 database definition language in accordance with the predetermined database definitions, and provides 625 the database definition language as the database definition language module 140, and the operation 600 ends 630.

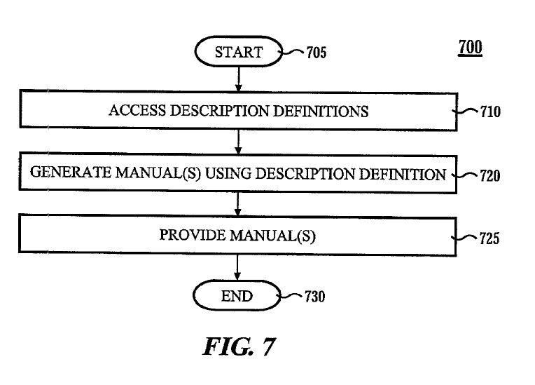

With reference to FIG. 7 the operation 700 of the manual program generator 195 starts 705 with the manual program generator 195 accessing the memory 170 to get 710 descriptions definitions 224. The manual program generator 195 then generates 720 manual(s) using the description definitions 224, and provides 725 the generated manual(s), after which the operation 700 ends 730. The manual program module 145 creates manuals, such as user and technical manuals, for the generated program modules 110 in accordance with the description definitions 224. There are programmer options to select via the graphical user interface 150 from a predetermined variety of manuals, the manual(s) that are to be generated. There can also be provisions for selecting whether the manual(s) are to be provided in hardcopy or softcopy or both.

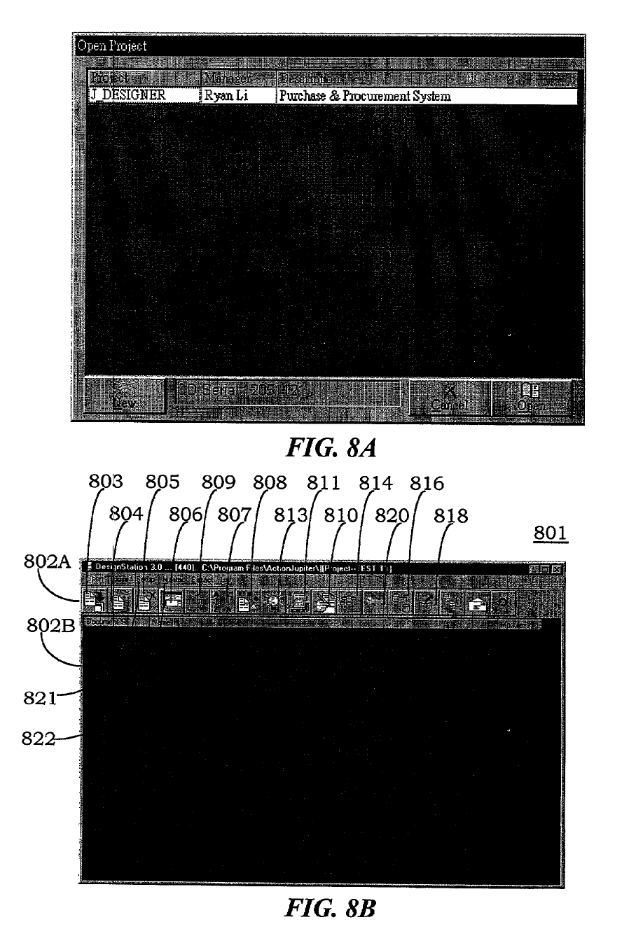

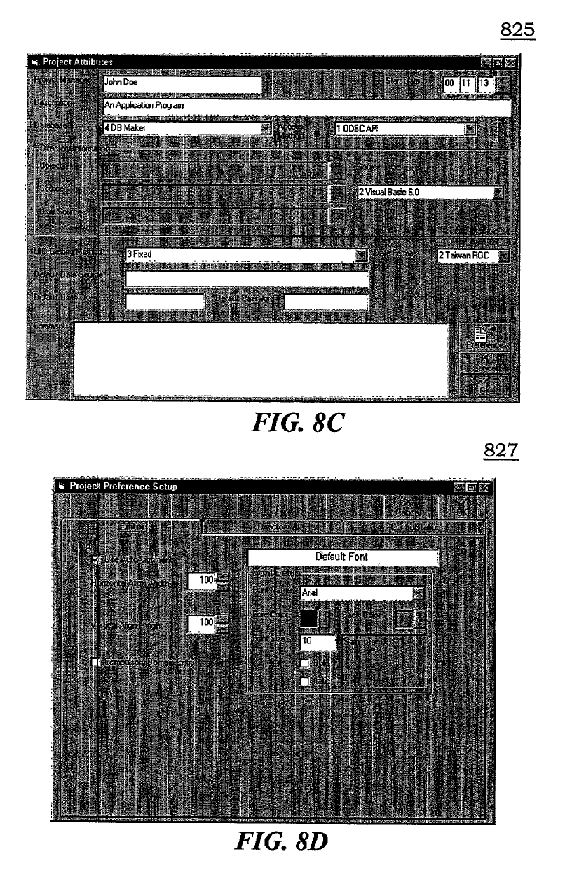

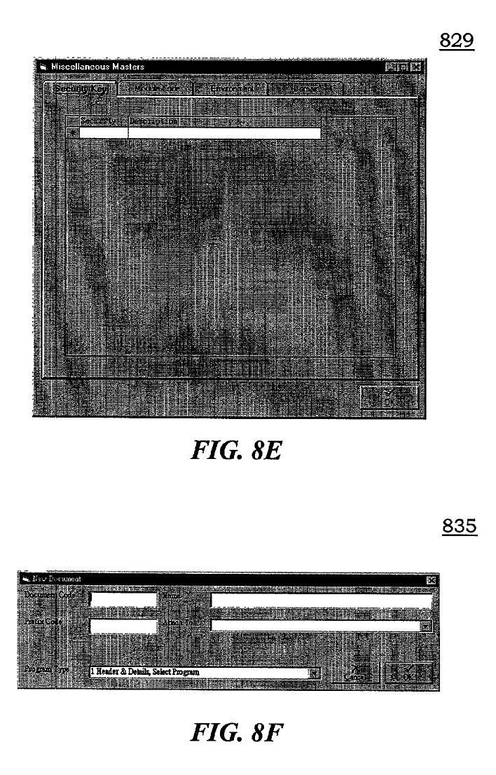

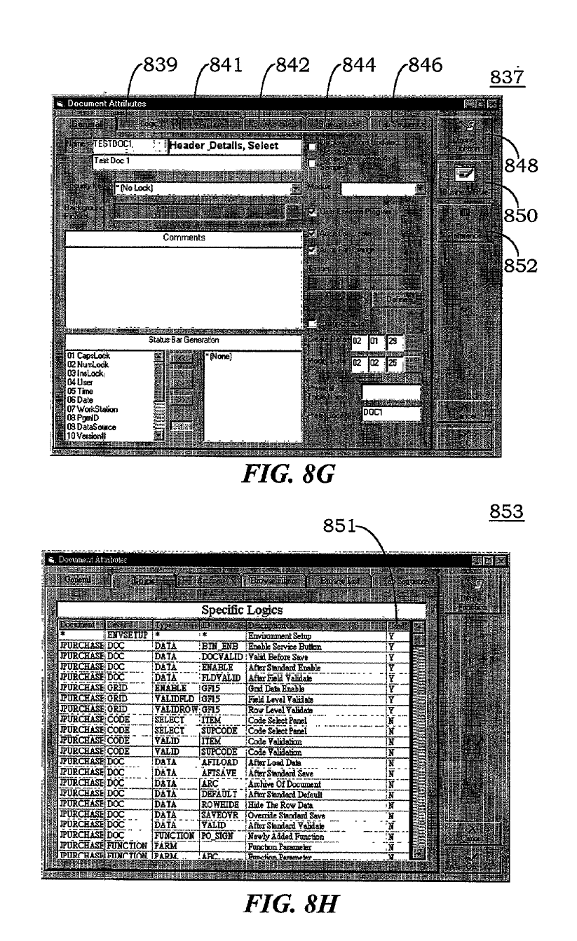

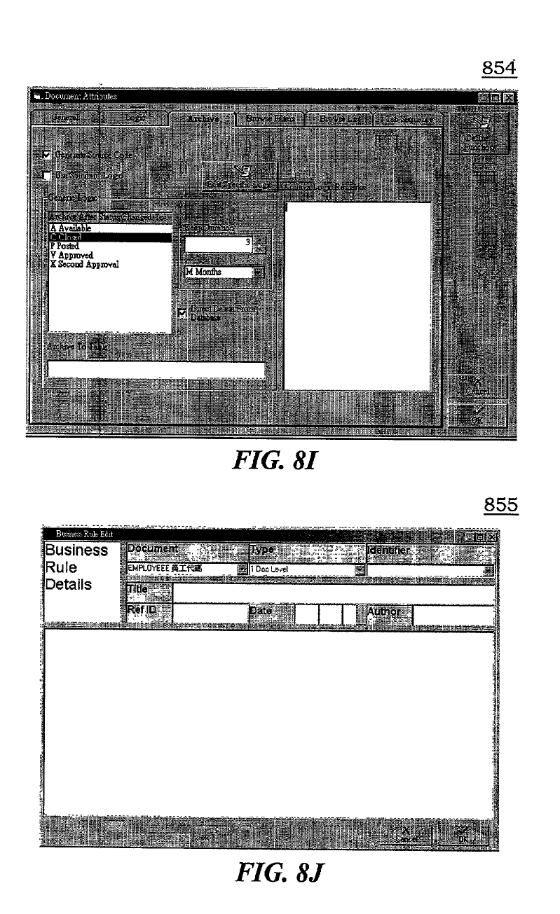

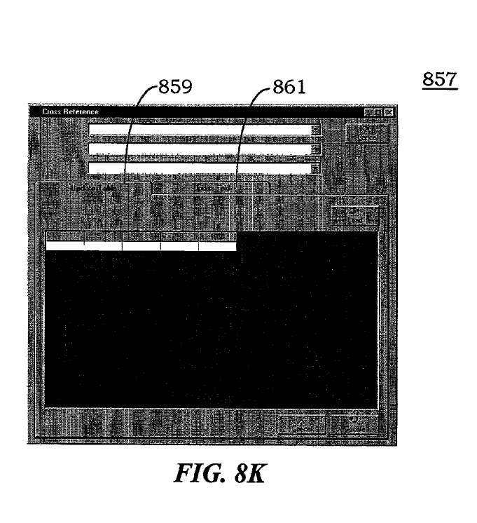

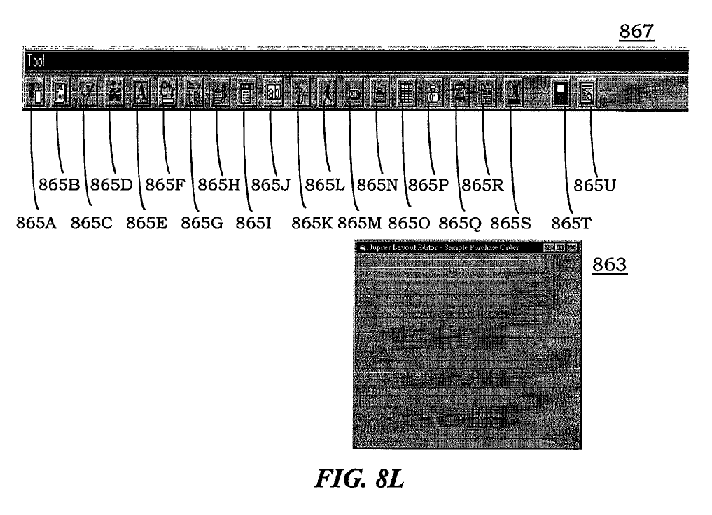

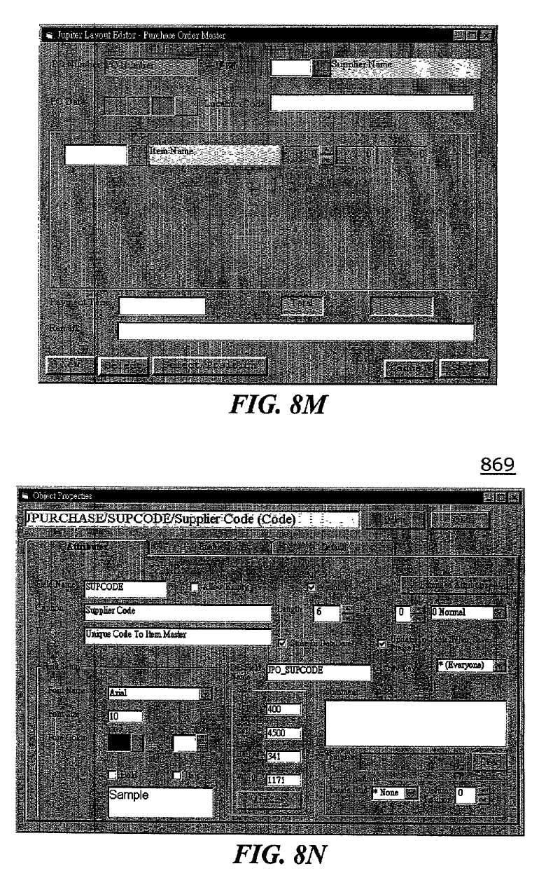

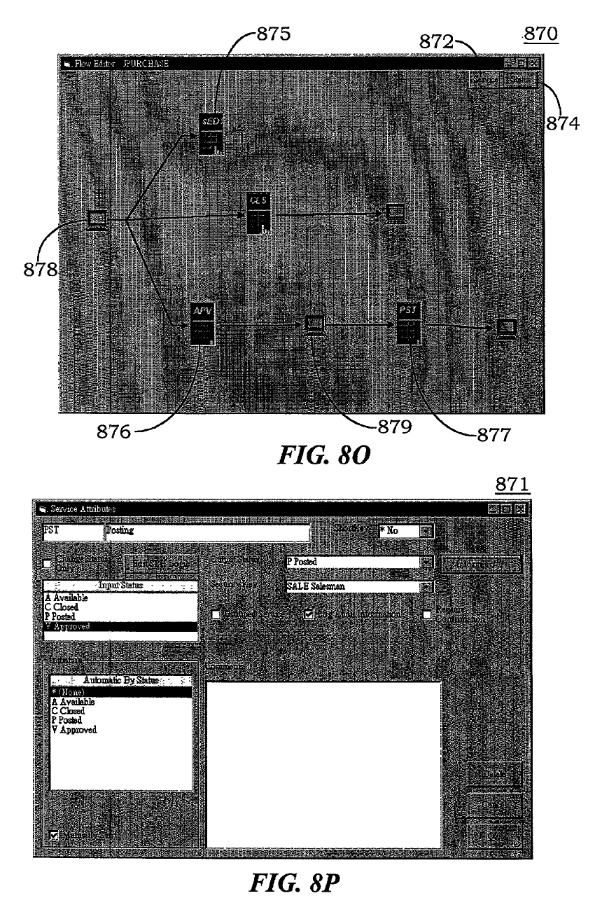

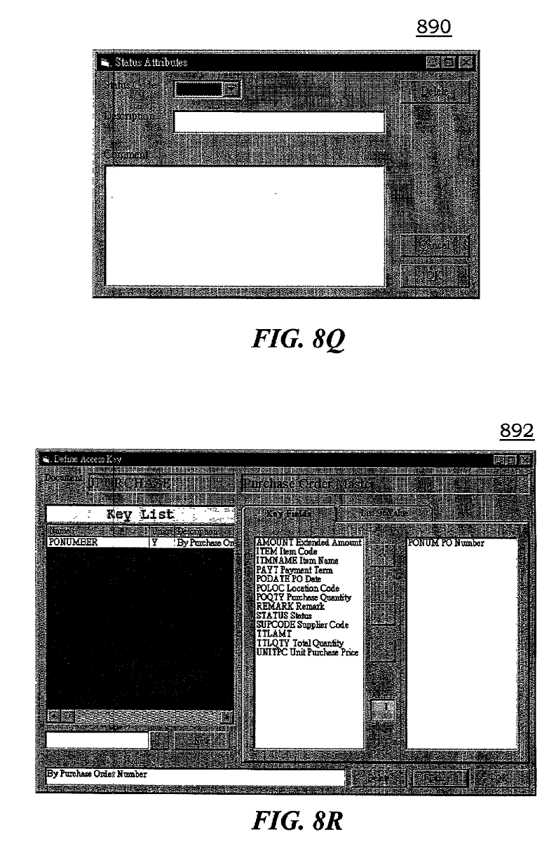

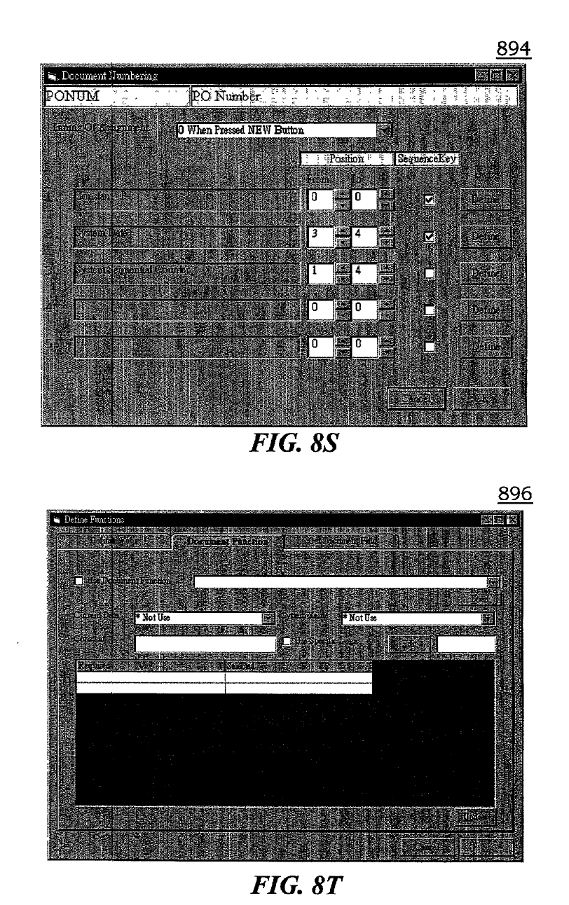

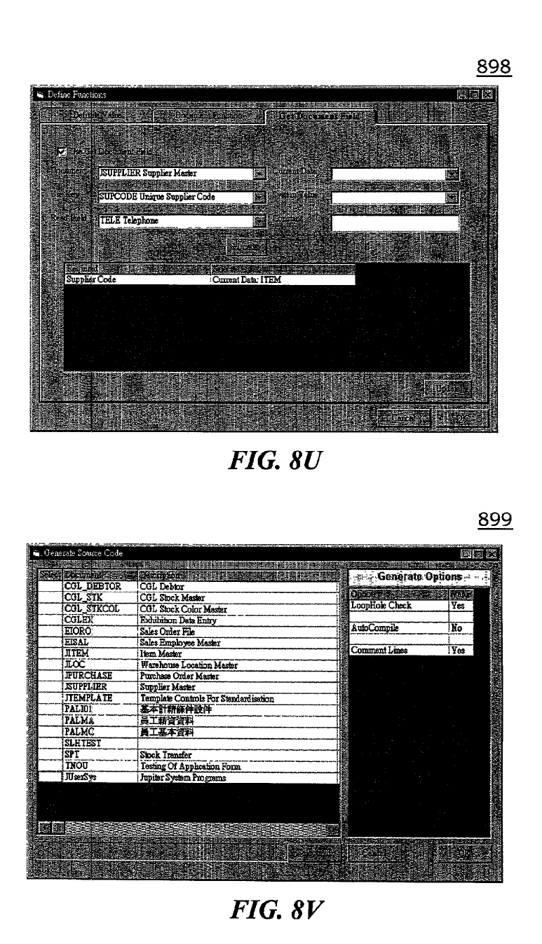

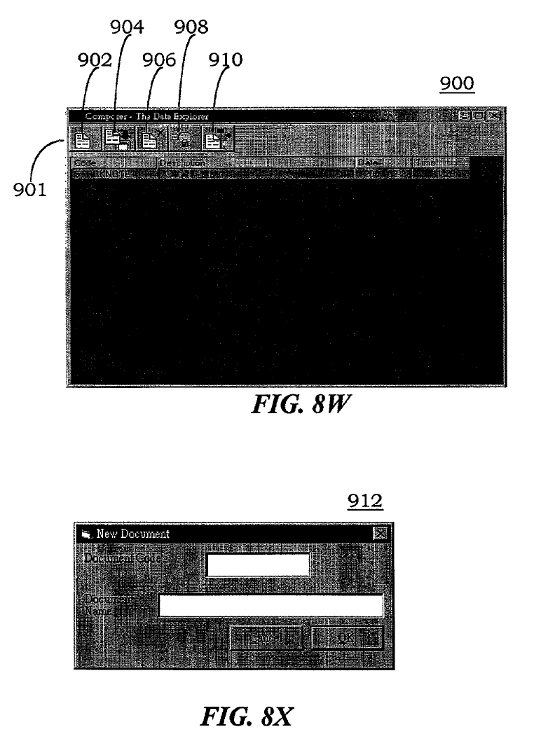

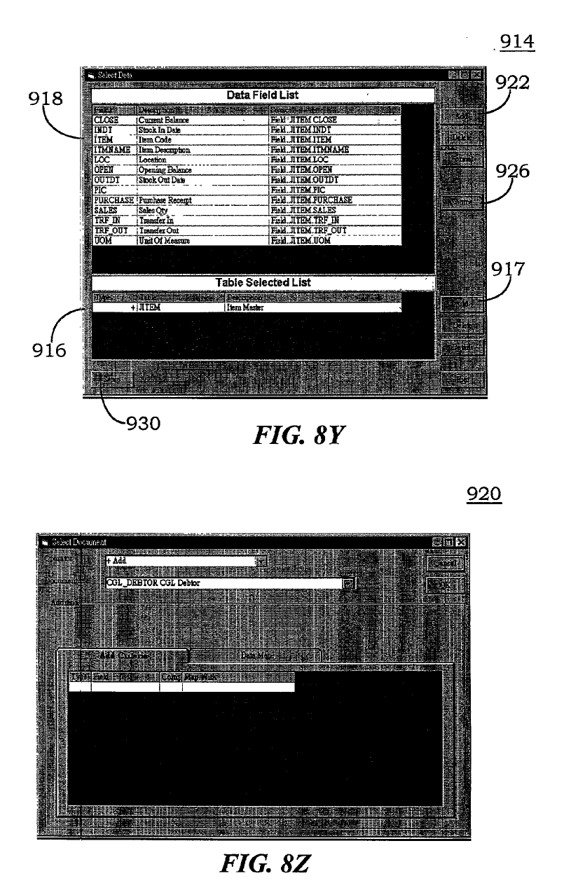

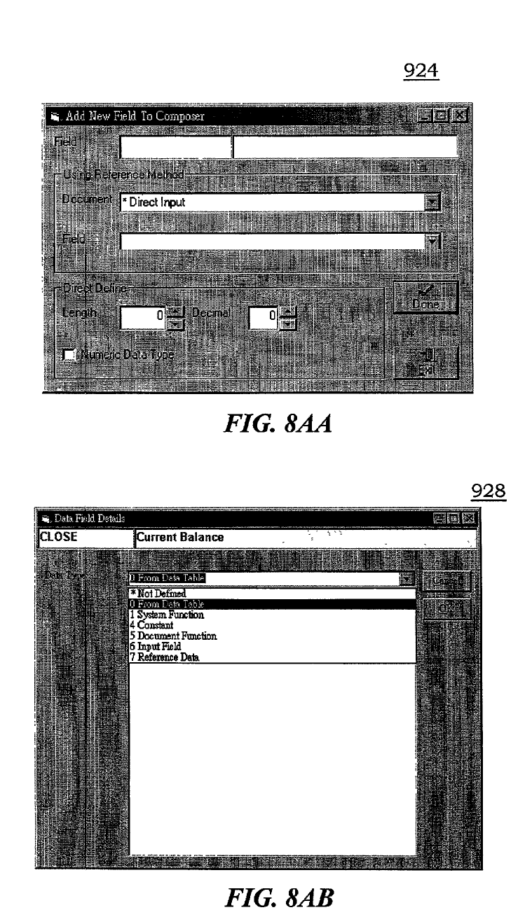

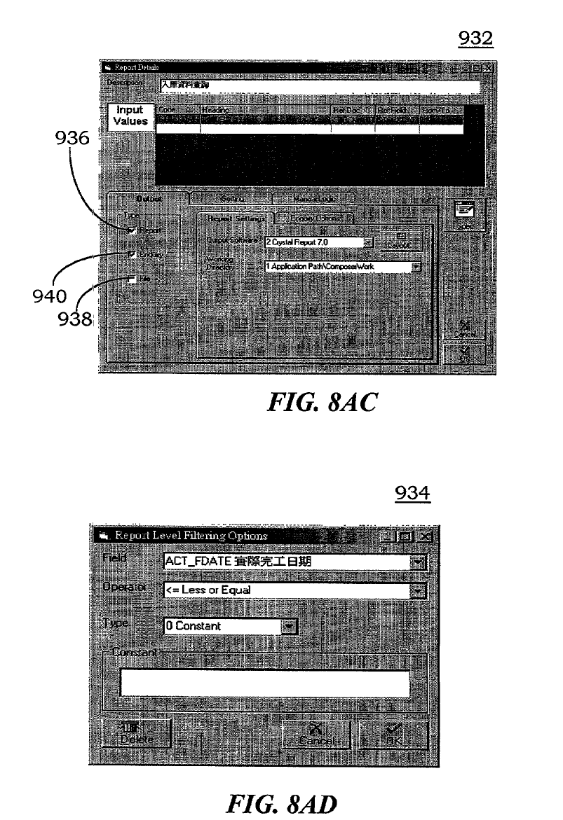

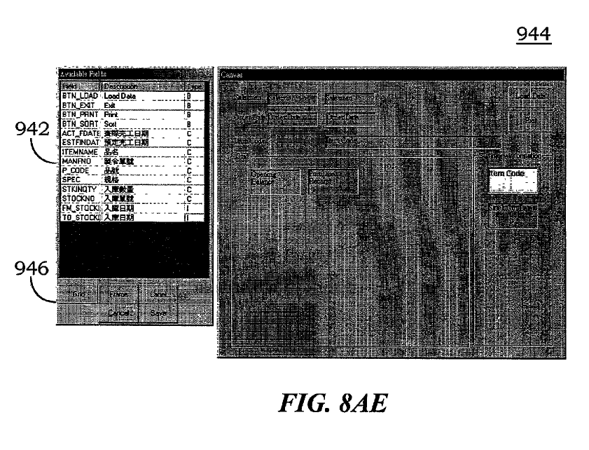

With reference to FIGS. 8A-8AE a description of the operation of an embodiment of the compilable application program generator 100 in the form of a computer program running on a computer now follows. For this portion of the description a user, which will be referred to hereafter as a programmer, and the programmer uses the compilable application program generator 100 to produce a generated compilable application program for a business operation. The programmer is provided with the documents, the process flow of the documents, and the reports that are used in the operation of the business. It is anticipated that the programmer is one with some knowledge of software programming for commercial applications.

The compilable application program generator 100 organizes compilable program generation by projects. When the compilable application program generator 100 is executed on the computer, the programmer is provided with the options of starting a new project, or continuing work on an existing project, as shown in FIG. 8A.

When an existing project is selected or a new one started, a main menu 801, as shown in FIG. 8B, presents the programmer with a number of command options 802A and a list of document files 802B. The document files 802B are based on the document specifications 115 of the documents that are used in the business operation. As shown in FIG. 8B, initially there will not be any document files listed.

The command options 802A includes selections for copying 803, creating 804, and deleting 805 document files. Document related commands include selections for document layout 806, document access 807, and document attributes 808. The commands 803-808 collectively perform the primary functions of the document creator 155. Document flow related commands include a selection for process flow 809, which performs the function of the process flow charter 160. Report related commands include a selection for report program generation 810, which performs the function of the report composer 165. Manual generation related commands include a manual selection 811 for specifying technical and user manuals to be generated for the generated program modules 110. In addition, a program generation selection 813 initiates the data processing program generator 180. An organization chart selection 814 provides a diagram of the business organization that this project applies to, and the diagram of the business organization is linked to security setup. The compilable application program generator 100 advantageously generates the data model using the definitions in the memory 170, that are produced from the user specifications 105 provided by the programmer via the graphical user interface 150.

Database related commands include a database link selection 816 to link a database to another, and a database capture selection 818 to capture data from an existing database. A security selection 820 allows the programmer to specify security attributes for the document files. The command options 802A also includes a Setup command 821, which produces a setup menu 825, as shown in FIG. 8C. Using this menu the programmer sets up the environment within which the compilable application program will be generated, and specifies a number of attributes of the compilable application program to be generated. The setup menu 825 also allows the programmer to specify project details, storage location of files, and logon control of the compilable application program to be generated that are included in the attributes. TABLE 1, which follows, lists the various attributes in specification fields of the setup menu 825, and provides a description of the function of each of the specification fields.

TABLE 1

| Specification | |
|---|---|
| Field | Description of Function |
| Start Date | The date on which this project was started. |
| Project Manager | The name of the project manager. |
| Description | Information about the project manager. |
| Database | Defines the type of database to be used. |
| Access Method | Defines the method of accessing the database. |
| Directory | Defines detail path where the source and object |
| Information | code generated by the compilable application |
| | program generator are stored. |
| Source Type | In the preferred embodiment Visual Basic is |
| | employed, and the version of Visual Basis is |
| | provided here. |
| Default Data | Provide logon control, and is usually used at |
| Source/Default | testing stage. |
| User ID/ | |
| Default | |
| Password | |
| UID Getting | For a user station menu, this indicates that |
| Method | the user will execute programs through the |
| | program list at a User Station. Therefore the |
| | logon User ID is obtained from the User |
| | station. |
| | For a user station agent, this indicates that |
| | the user will execute programs that are not |
| | provided through the program list at the User |
| | Station. Therefore, a background agent is |
| | activated to obtain the logon User ID. |
| | There is also a fixed method where the logon |
| | User ID is provided by the Default Data |
| | Source/Default User ID/Default Password. |
| Date Format | Sets the format of the presentation of the |
| | date. |
| Comment | Text that describes the present project, and is |
| | used when printing manuals and the like. |

In addition, the programmer can specify preferences as a part of the setup menu 805 via a preferences menu 827 shown in FIG. 8D. Such preferences include default editing font selections, specifying the storage location(s) of directories for the compilable application program template to be used, and specifying the storage location of a database application, such as Visual Basic by Microsoft Inc. of the USA, that is to be used to produce the compilable application program. In addition, there is also the option to specify the storage location of a report output formatting program, such as Crystal Report by Seagate Inc. of USA, which is to be used for formatting output data from the report program module 135, when executed. With the preferences menu 827 the programmer can also specify whether the compilable application program generator 100 operates in a standalone mode i.e. as a single workstation or User Station, or a collaborative mode where a number of User workstations are employed by a number of programmers. When the collaborative mode is used, the programmer can further specify the necessary information, such as Internet Protocol (IP) address and Port numbers of the user workstations operating in collaboration to develop the compilable application program.

Returning now to FIG. 8B, the commands option 802A further includes a Master command 822 that produces a master selection menu 829, as shown in FIG. 8E. On this screen, the programmer specifies security key systems, module organization of the document files, define global variables, and grouping of data fields, for the compilable application program that is to be generated. Using the Master menu 829, the programmer can define several security keys which, may apply to a particular document file, a particular data field, or a particular service level in the process flow of a particular document file. The specification of which users are allowed to use which keys is defined by a designated administration program, which may be bundled with the compilable application program generator 100.

Modules and the association between document files and modules can be defined by the programmer using the Master menu 829 in order to provide a classification system. The global variables, also referred to as environmental variables, are defined by the programmer with the Master menu 829 to be set up by the generated compilable application program for convenient access at start up, when the generated compilable application program is executed. There are also provisions for the programmer to add a source code program for detail processing logic, using Visual Basic syntax, for example, to set up the global variables. Further, the Master menu 829 allows domain tags to be defined for use at field level to group data fields into different domains and entities. This grouping allows the compiled application program generator 100 to check attributes of data fields of a common domain or entity for consistency.

Returning to FIG. 8B when the programmer creates a new document file using the Create command 804 a new document screen 835, as shown in FIG. 8F, allows the programmer to input a document code, a name or label for the document, a prefix code, and to select a program type. The document code identifies a new document file and a new database table. Usually, the document code is the database table name that will be automatically created by the compilable application program generator 100. The document code is unique within a project, and in a preferred embodiment has a maximum length of twenty characters. In contrast, the document name is only used for reference purposes.

The prefix code is the prefix that is used in the database field, and the name of data fields in a document having a predetermined prefix code will have the prefix code prefixed thereto. The program type is the style of document that is being created. Several document types are defined and these include: header and details type where more than one database table is created; a processing form type where there is no need to save screen content; and header only type, which is similar to the header and details type, however only one database table is not created. In addition the programmer can use an “Attach To” command to specify an existing database table that is to be shared with the document file that is being created.

After creating a new document file, the programmer then specifies attributes of the new document by activating the document attributes 808 command, and using the document attributes menu 837, which is shown in FIG. 8G. The various specification fields of the document attributes menu 837, and their respective functions are detailed in TABLE 2 below.

TABLE 2

| Specification | |
|---|---|
| Field | Description of Function |
| Name | A descriptive name for the current document, |
| | which is only used for reference purpose and |
| | has no impact on any logic processing. |
| Security Key | A security key as defined in the project |
| | attributes. When a user is allowed to use a |
| | security key then the user will have access to |
| | edit the current document. However, data field |
| | access for editing and process flow is at |
| | another control level. |
| Module, Create | Register the information about this document, |
| Date, Modify | for record keeping purpose only, and has no |
| Date | impact on the generated code. |
| Comment | Text description of the current document, which |
| | is used primarily in the printing of manuals, |
| | such as a User Guide and other documentation. |
| Audit For Create | Controls whether audit information (Date, Time, |
| | User & Workstation) should be recorded, for |
| | example when a user insert records or when |
| | editing the current document. |
| Audit For | Controls whether audit information for any |
| Change | changes of record should be logged, the |
| | information that is logged is the same as in |
| | Audit For Create. |
| Logging Level | Controls whether the whole record |
| | image should be logged when data is changed. |
| Components | Determines whether components that have been |
| Served As | defined in the current document can be accessed |
| Template | in other documents as a sample, so that |
| | attributes can be copied for similar documents |
| | or data fields. |
| Prefix Code | Prefix characters for the data fields in the |
| | current document in a database table. |
| Status Bar | Specifies whether the status bar that is |
| | displayed at the bottom of the screen should |
| | be generated for this program, and specifies the |
| | displayed information. |
| Physical Table | Is the database table name in the database. |
| Name | This is allowed to be input by user to cater |
| | for cases that the database table already exist |
| | as in existing systems. |
| Update Message | Specifies whether the 'Record Updated' message |
| | should be displayed after user edits a record, |
| | activates a save function, and saves the change |
| | to a database. |
| Existing Table | A database table already exists in the |
| | database, and when selected, the programmer |
| | must specify the existing physical database |
| | table name and the prefix code. |

With reference to FIG. 8G, the programmer can also specify specific source code programs. When a logic tab 839 is selected, a variety of redefined source code programs are displayed in a logic menu 853, which is shown in FIG. 8H. The list of source code programs, which will be referred to as specific logic hooks (SLH), can be selected by the programmer. Alternatively, a SLH can be selected and modified in source code form. In addition, SLHs can be enabled or disabled by setting the selection in the Used column 851. Only the enabled SLHs will be considered by the compilable application program generator 100 when generating the compilable application program.

Specific Logic Hooks (SLHs)

For most generated compilable application programs, the list of predefined SLHs caters to the needs of normal processing logic, especially ones that relate to screen or display management, validation, determining a field is usable by a user, and providing a default value for a field when the user edits the document. However, there tends to be the need for logic, which cannot be anticipated but is required in a particular business operation. As there is no available means to generalize such needs, it is difficult if not impossible for any compilable application program generator to generate such logic. Examples are, updating of stock balance based on receipt transaction or posting to a general ledger.

The compilable application program generator 100 advantageously employs SLHs, that allow a programmer to edit existing SLHs or even define new ones. In addition, there is no need to rewrite SLHs when regenerating the compilable program as all SLHs are preserved during generation of the compilable application program. Hence, changes can be made to, for example, the layout of a document, and the compilable application program can be regenerated immediately.

A description now follows on the various aspects of SLHs. SLHs are embedded in the compilable application program generator and provide the following features:

a variety of SLHs to support a variety of requirements;

ease of use, where selection via the graphical user interface allows the programmer to edit the source code of a SLH, without the need to separately start, for example, the Visual Basic application program;

data fields and internal variables are defined in data structure, and the data structure encapsulates technical details, in addition validation of data fields can be done automatically; and

whenever there are changes in the document layout, only regeneration of the compilable application program is required.

Using SLHs to Get Data on the Screen

When an SLH is used to perform calculations, the data that has been keyed in or entered by users must be accessed, and this can take the form of an internal variable, such as a user identification (ID), system date, terminal identification (ID), number of rows in the grid, and accessing database data.

When an SLH is edited, the compilable application program generator 100 creates temporary data structures that describe the data on the screen, and which includes the current image on the screen, the previous edited image, and the database image prior to editing. Besides the data of the current document in which the SLH is being edited, the compilable application program generator 100 also creates data structures that contain global variables, useful functions and subroutines in a library.

When editing a SLH, the programmer edits the source as he would a Visual Basic program, for example, except that all the data is not on the screen but is stored in data structures. Grid data is accessed through a built-in function. For some SLHs, a return code is required. Here, the programmer has to set the return code so that the compilable application program generator 100 knows whether the programmer wants to abort the operation or to commit changes.

Using SLHs to Return Data

In most of the cases, information is provided after processing, and such requirements usually fall into 2 categories i.e. return data and return status. For return data, the programmer can alter data by changing the content of the data structures. After the data structure has been changes, either data on the screen, or the processing logic will be effected. For some SLH processing, there is a requirement to pass status upon exiting a function. Typically, status is in the format of a string, composed of several characters. For example, the format may be as follows: Xyyyy, where X is Y for successful, N for fail; and

yyyy is any return code, however, typically it is the message code.

Using SLHs to Access Database

SLHs can be used to read or update records in a database in accordance with business logic. There are two areas which are of concern, i.e. database handle and commitment boundary.

The compilable application program generator 100 provides different approaches to accessing the database, such as DAO, ADO, API etc. However, using SLHs the database is accessed quite differently, and depends on the access method selected by the programmer. The database handle is defined in a different format, as listed below.

| | |
|---|---|
| DAO Defined as : SysDB | As Database |
| ADO Defined as : Public ADO_DB | As ADODB.Connection |
| API Defined as : Public SDB | As Integer |

Typically, the compilable application program generator 100 handles all the commitment for the generated compilable application program. Commit will only be executed if all the return codes from SLH indicates success. If during execution of any SLH a fail condition results, then the compilable application program generator 100 will rollback the processing. It is important not to carry out a commit operation in a single SLH, since functions may be nested and commit should be done only when the whole transaction is successful.

When a programmer wants to include more files, such as additional forms and/or modules into a SLH. The editor of the compilable application program generator 100 supports this feature. Hence, when editing a SLH using a Visual Basic editor, for example, the programmer can include files as normal Visual Basic programs, and upon saving the project, the compilable application program generator 100 will automatically scan the source code, and remember which additional forms and/or modules have been included. TABLE 3 below provides a listing of some SLHs, along with a description of their function.

TABLES

| SLH | Time Of | |
|---|---|---|
| Function | Trigger | Description of Function |
| Environment | Start of | This is used to setup the |
| Setup | program | environmental variables that |
| | | have been defined. When |
| | | called, the database is |
| | | already opened. |
| Document | Manually | This is the override logic to |
| Archive | started - | determine whether a record is |
| | House | required to be archived from |
| | keeping | the system. |
| | program | |
| | archive | |
| Document | Exit from | This is the logic to set |
| Default | every field | default values for every data |
| | | field in the header area, |
| | | and is called after the |
| | | validation of the data fields |
| | | is successful. |
| Document | After | Enables/disables header |
| Enable | validation & | fields, after the standard |
| | default | logic defined in the |
| | | attributes. |
| Document | After | After standard validation, |
| Validate | standard | when there are no errors, |
| | validation | then this routine is called, |
| | before save | for a programmer to carry |
| | | out an application check. |
| Document | After | After standard validation, |
| Field | standard | when there are no errors, |
| Validate | validation for | then this routine will be |
| | a field | called, for a programmer to |
| | | carry out an application |
| | | check for this particular |
| | | data field. |
| Document | After user | This logic replaces the |
| Save | activates | standard save logic |
| Override | save | generated. |
| | function | |
| Document | After saved | Used after save is to be |
| After Save | to database | carried out, and may include |
| | | updating of any other tables, |
| | | for example, update the |
| | | Goods In Transit quantity in |
| | | the stock balance file. |
| Document | After record | Used after the system has |
| After Load | is loaded | loaded the data according to |
| | | the record selection, and |
| | | before displaying the data on |
| | | a screen. |
| Document | Hide the row | Used after the After Load |
| Row Hide | data | event, to suppress the data |
| | | from being displayed |
| | | according to the programmer's |
| | | specified logic. Normally, |
| | | this is used to cater for row |
| | | level security check. |
| Function | When | When a programmer decides to |
| Parameter | function is | use his own logic to feed |
| | being called | information to a function, |
| | | then when the function is |
| | | called, this routine will be |
| | | initiated. |
| Document | When | If a programmer has defined a |
| Function | referred | document function, whenever |
| | | the function is referred to |
| | | by any other portion of the |
| | | program, this source code |
| | | will be executed. |
| Service | When service | Whenever a service is called, |
| | is called | either by pressing a button, |
| | | automatically, or selected |
| | | from a list, this routine |
| | | will be initiated |
| Status Load | Program | When a user chooses to load a |
| | start | status list manually by |
| | | logic, then whenever the |
| | | program is started, the |
| | | status load routine |
| | | for that control will be |
| | | initiated. |
| Code Select | User | When a user activates a |
| | activates the | select button, if standard |
| | select button | logic is not going to be |
| | of the code | used, then this routine will |
| | | be initiated. |
| Code | When exit of | When standard validation of |
| Validate | the code field | the code is not going to be |
| | | used, then when the focus is |
| | | lost from the code field, |
| | | this routine will |
| | | be initiated. |
| Grid | | A grid routine has the same |
| Routines | | SLHs as a document, and |
| | | include Enable, Default, |
| | | After Save, Override Save, |
| | | and Validate. A grid routine |
| | | has the same effect as in the |
| | | document, however the effect |
| | | is only applied to a |
| | | particular grid. |
| Grid | Override the | This replaces the default |
| Overload | loading | loading method of the grid |
| | | data, and a programmer can |
| | | totally load the grid data by |
| | | using his own code. |
| Before Load | Before the | This routine is called before |
| | loading | an SQL statement is issued |
| | | to a database. |
| Summary | Grid | This routine is called after |
| | summary | validation of all the rows |
| | | inside the grid, and before |
| | | displaying the data to the |
| | | screen. |
| Direct | When user | This is used to execute some |
| Button | presses the | code when user press the |
| | direct | button for processing form |
| | execution | programs. |
| | button for | |
| | processing | |
| | form | |
| | programs. | |

Returning now to FIG. 8G, the programmer can also specify archives. When an archive tab 841 is selected an archive menu 854, as shown in FIG. 8I, is provided. The programmer uses the archive menu 854 to specify a variety of archive parameters, and TABLE 4, which follows, lists some archive specification fields and provides respective descriptions.

TABLE 4

| Specification Field | Description of Function |
|---|---|
| Generate Source | Specifies whether source code needs to be |
| Code | generated to handle the data archive. This is |
| | done when the programmer specifies generation |
| | for documents in the generation screen. |
| Use Specific Logic | Indicates whether standard archive logic, as |
| | will be describe later, should be used, or |
| | whether the programmer will provide logic to |
| | be used when creating an archive house keeping |
| | program. If this box is checked, then the |
| | programmer can use the Edit button to input |
| | his own code or specific logic. |
| Generic Logic | This is logic provided by the compilable |
| | application program generator 100, and will |
| | only be effective if the Use Specific Logic |
| | option is not selected. |
| Status Changed | Indicates the status of a document, as will be |
| To | described later for the process flow charter |
| | 160 later, is ready to be archived. |
| Keep Duration | Indicates how long data should be kept after |
| | their status has changed as specified in the |
| | 'Status Changed To' option, after which the |
| | data is removed from the system. The specified |
| | duration can be days, months or years. |
| Direct Delete | When selected, records will be removed from |
| From Database | the database when the archive housekeeping |
| | program is executed. When not selected, |
| | nothing is deleted from the database. |
| Archive To Table | When this field is filled with any code, then |
| | the code will be used as a table name, and |
| | records deleted from the system will be moved |
| | to this table. It should be noted that only if |
| | the insert is successful, then the data will |
| | be removed from the system. |
| Remark/ | This is a narrative description of the archive |
| Comments, | process, and is only used in the documentation |
| | printing of manuals. |

With reference again to FIG. 8G, the browse filters and browse list tabs 842 and 844 supports editing of records. Typically, when editing records a screen will be required for a user to select records to be edited. The browse filters and browse list tabs 842 and 844 allow the programmer to specify how the filtering and selection screens are created.

Again with reference to FIG. 8G, the tab sequence tab 846 allows the programmer to set the sequence of data fields through which a cursor moves when tabbed.

Still referring to FIG. 8G, a define function command 848 when selected allows a programmer to define a function, which can then be referred to from other document files. When a document file refers to a function, parameters are mapped from the data available from that document file, and the function then returns a result. The detail logic of a function is written in Visual Basic, in the preferred embodiment.

Again from FIG. 8G a business rule command 850 when selected provides a business rule window 855, as shown in FIG. 8J. During development of the compilable application program, many business rules and know-how inherent in the particular business operation that will utilize the resultant executable form of the generated compiled application program, needs to be captured and subsequently reproduced in user and technical manuals. The business rule window 855 allows the programmer to enter such information in various screens, such as the document attributes screen 837, and also a service attributes screen, that will be described later.

With further reference to FIG. 8G, a cross reference command 852 when selected provides a cross reference screen 857 as shown in FIG. 8K. A programmer can use the cross-reference screen 857 which provides a list of database tables 859 and a list of data fields 861. The programmer indicates from the lists the cross references to database tables in the current document with those on the list, and also indicates from the list of data fields 861 the cross-references to data fields in the current document. These cross-references are saved as definitions in definition tables in the definitions portion 205 of the memory 170.

Going back to FIG. 8B, selection of the document layout command 806 produces a document layout screen 863 as shown in FIG. 8L, of a layout editor. In addition, a number of layout tools 865A-865U in a layout tool bar 867 is provided. TABLE 5 below provides a listing and a graphic of some of the layout tools 865A-865U along with a description of their respective functions.

TABLE 5

| Requirement | To be provided | Controls To Be Used |
|---|---|---|
| Only Yes/ No type | [symbol] | True False |
| Is a key to a table | [symbol] | Code |
| Is a memo field only | [symbol] | Text |
| Only want to have upper case | [symbol] | Code |
| Figures | [symbol] , [symbol] | Qty, Price |
| Percentage | [symbol] | Discount |
| Output Labels | [symbol] | Label |
| Display value from another table | [symbol] | Reference Data |
| Action | [symbol] | Button |
| A List Of Value To Choose From | [symbol] | Status |
| Derived Fields/ System Environment | [symbol] | Function Field |
| Date | [symbol] | Date |

The programmer uses the document layout screen 863 and the layout tools 865A-865U to recreate or design documents that are used in a business operation. The layout editor performs the function of the document creator 155. The created document contains various data items such as fill-in areas, and also displays information. Not all the information on the screen needs to be saved in a database. In addition, the document can have action buttons. Hence, in a document, there are different data items or controls, and they can be grouped into several categories, namely: data fields which allow a user to provide input, output, and the data is stored in the database; labels for display only, such as headings; reference fields also for display only, however these fields may be derived from other fields, or from another database table; and action, which is often represented as a button.

When creating a document the above mentioned data items, can be re-classified as: input data fields that allow a user to key in data, and require particular logic, such as default value, validation, enabling etc.; output data fields that are either constant or reference data by reading information from related database tables; and action buttons which include standard buttons such as new, cancel, save, select, etc. In addition, there may be user defined buttons for specific user defined services, such as posting, approval, etc.

In operation, when the layout editor is invoked, the programmer is initially presented with a blank layout as shown in FIG. 8L. The size of the layout can be changed, and the data items are incorporated using the layout tools 865A-865U in accordance with the programmer's specifications. The programmer incorporates the data items, which include data fields and objects, into a current document that is being created or designed. The layout tools include:

Template selection 865A for the programmer to select from predefined templates for a variety of data fields;

Save Designed Document 865T for saving the current design; and Preview Designed Document 865U for previewing the current document.

The layout tools for specific data items include tools for:

Date fields 865B;

Boolean data fields 865C;

Quantity data fields 865D;

Label fields 865E;

Code fields 865F;

File names fields 865G;

Price fields 865H;

Status fields 865I;

Text fields 865J;

Discount fields 865K;

Multimedia objects 865L;

Action buttons 865M;

Frames 865N;

Grid array fields 865O;

Document numbering fields 865P;

System function fields 865Q;

Tabbed folders 865R; and

Reference data fields 865S.

A sample of a purchase order created with the layout editor is shown in FIG. 8M. After selecting one of the layout tools for incorporating a respective data item, which here is a data field, into the blank layout, the programmer provides specifications of the data field using a data field attributes screen 869, as shown in FIG. 8N. TABLE 6, which follows, lists some of the specification fields and provides respective descriptions, in accordance with the attributes supported.

TABLE 6

| Specification | |
|---|---|
| Field | Description of Function |
| Field Name | Any unique code within the current document |
| | that is used to identify the current data |
| | field. |
| Allow Empty | Allow the current data filed to be empty when |
| | saving the record. |
| Visible | Selects whether the current data field is |
| | displayed. |
| Caption | Text displayed as caption for the current data |
| | field. |
| Hint | A tool tip for the current data field to be |
| | displayed. |
| Length/Decimal | The length and decimal points for the current |
| | data field in the database. |
| Store In Database | Indicates the current data field is a database |
| | field, not a working field. |
| Update To Table | Determines whether the current data field will |
| When Save | be saved according to the value on the |
| Pressed | screen. |
| Database Field | Name of the current data field declared in the |
| Name | database layout. This specification field |
| | will be automatically assigned during |
| | generation if it is empty. |
| Grid | Indicates which grid (folder/frame) of the |
| Table/Position | data field will be embedded. If it is a grid, |
| | then the position will indicate the column in |
| | which the current data field is to be shown. |
| Visible Only To | The security key that the current data field |
| | is going to be secured with. Only those who |
| | can use this key will be allowed to view/edit |
| | the contents. |
| Font Information | Specifies the display attributes to be used, |
| | including the size, color, font of the current |
| | data field. |
| Round Type | Specifies that the contents in the current |
| | data field is to be rounded. This is applied |
| | only to numeric data fields, and the contents |
| | will be rounded, both after exiting of the |
| | current data field after editing, |
| | and also before saving of the data to the |
| | database. |
| Size | The size, in pixel, of an action button. The |
| | auto-sized button is provided to automatically |
| | calculate the minimum size of the control |
| | button using the specified font. |
| Template | This contains the document and field name of |
| | the original template, if this field is |
| | created by activating the template button. If |
| | this field is not empty, the compilable |
| | application program generator 100, will |
| | reference the template field's field length |
| | and decimal point, to generate the new |
| | source, i.e. this standardizes the field |
| | length by just specifying the size once in the |
| | template. |

The data attributes screen 869 also allows the programmer to specify how to enable or disable a particular data field when the document with that particular data field is newly created or retrieved for editing. Again SLHs may be specified here. In addition, the programmer can specify default values for the data field.

The data attributes screen 869 also includes access to extended attributes that allows a programmer to input additional specifications for the data field, such as, presenting filtered lists from a database table for a user to choose from; checking user input against data tables; specifying a range of allowed values; and automatically assigning sequential numbers. As with the attributes of the data fields, the programmer chooses a variety of specifications for the extended attributes via the document creator 155 of the graphical user interface 150. Hence, data field specifications are provided by the programmer as attributes and extended attributes, which result in the data definitions 223.

A description of how some of the data fields are incorporated into a current document now follows.

The code field tool 865F in FIG. 8L defines a data field that is normally linked to other documents and which requires checking. When the current document being checked uses a composite access key, then more then one data field needs to be set so that validation can be carried out. In addition, there is a provision to setup the selection screen that will be displayed to a user, and provide the user with a choice of records that the user wants checked. TABLE 7 below lists details of the various specification fields that are available to the programmer and a description of their functions that are supported by the attributes of the code field tool 865F.

TABLE 7

| Specification | |
|---|---|
| Field | Description of Function |
| Use Specific Logic | Use SLH to check the input code. |
| Check Against | The document that is to be checked and the |
| Document/ | access key that the checking is to follow. |
| Check Using Key | |
| Error Message | When a record cannot be found in the checking |
| | document (one or more), then this message will |
| | be displayed. The programmer determines the |
| | message. |
| Selection Panel | This panel allow the programmer to set the |
| | data fields for the selection panel. When the |
| | programmer activates the list button when |
| | entering this code field, the compilable |
| | application program generator 100 will base on |
| | the access key that is going to be validated, |
| | and displays the List of Value panel |
| | according to the setting in the Access Key |
| | Setup. If the access key has more than one |
| | data field, the programmer can set the default |
| | value for these filtering fields, and specify |
| | whether these filters can be changed by a |
| | user. |
| Specific Load | Specifies whether SLH is used to display the |
| Logic | selection panel screen. |
| Buffer | For storing ancillary data fields after |
| | checking a particular document, such as |
| | storing the unit price after check an item |
| | code. In this panel, the programmer can choose |
| | which other data fields need to be stored in |
| | the temporary buffer. |
| Pattern Check | This is used to control some additional |
| | characteristic. |
| | Such as: Must Be Fill - Specify whether the data field must be fully inputted by a user; |
| | Char Allow - Specify the characters that are |
| | allowed to be in the code; and |
| | Pattern Check - This carries out some predefined check digits algorithm. |

The document number field tool 865P in FIG. 8L is used to generate a document number by assembling different portions of information, and these portions can include current data, system value or post document function processing, as specified by the programmer using the attributes supported by the document number field tool 865P. TABLE 8 below lists details of the variety of specification fields and their functions.

TABLE 8

| Specification | |
|---|---|
| Field | Description of Function |
| Timing Of | Selectable between after the user activate the |
| Assignment | New function, or just before save to the |
| | database. |
| Data Fields | Upon activating the Define function, |
| (Define) | additional screens will be displayed, which |
| | allow specifications of the kind of data that |
| | is to be used as part of the document number. |
| | It can be constant, data field, or document |
| | function. |
| From/To | Allows the programmer to extract part of the |
| | data as the document number. For example, |
| | retrieve the first 6 characters of the system |
| | date, in order to get the YYYYMM. |
| Sequential Key | Indicates which field (from 1 to 5) to use as |
| | the unique key to allocate for the next |
| | available number. This is applicable only if |
| | one of the data fields selected is System |
| | Sequential Counter. For the above example, |
| | whenever the user saves a new record, a new |
| | document number will be automatically |
| | assigned, having the format, such as, P-YYMM. |

The quantity/price field tool 865D/865H in FIG. 8L, may be used for receiving user input, and for filtering out illegal characters. In addition, this tool may also be used for checking that user input is within an allowable range of values.

The status field tool 865I in FIG. 8L allows the programmer to specify different types of lists that provides a user with a predetermined range of choices. It supports single and multiple entries by the user, and the programmer can also specify where the contents of the lists are to be loaded from, and when the loading is to occur. TABLE 9 provides details on the specification fields for status fields and their respective functions, as supported by attributes of the status field tool 865I.

TABLE 9

| Specification | |
|---|---|
| Field | Description of Function |
| Style | 0 - Simple List (Select only one entry). |
| | 1 - Multiple Select List (same as 0, but can |
| | select multiple entries). |
| | 2 - Selection Panel, allow to choose multiple |
| | entries, and displayed in a more user friendly |
| | way. |
| | 3 - Option Button. |
| | 4 - Check Box. |
| Loading | 1 - From the document content, per the ‘From’ |
| Method | Doc specification. |
| | 2 - From constant list, per Constant |
| | specification. |
| | 3 - Use SLH, totally controlled by programming |
| | codes. |
| From | Indicates the document from which the list should |
| Document | be loaded, such as warehouse master etc. |
| Selection | The data field that is going to be selected, and |
| Field | stored into the current data field. This should |
| | be a field in the ‘from’ document. |
| Display Field | The field from the ‘from’ document, to be |
| | displayed side by side with the selection field. |
| | For example, a warehouse name. |
| Status To | The record with which status will be displayed. |
| Display | For example records with suspended status need |
| | not be displayed. |
| List Name | The Constant List to be loaded into the status |
| | field. A list is a collection of different |
| | entries in the lower part of the screen, so that |
| | the compilable application program generator 100 |
| | knows which part is required to be loaded. |
| Static Value | For setting up fixed number of list items, and |
| | can be done by activating the Edit button, and |
| | entering the codes and their respective |
| | descriptions in a resulting Edit Constant screen. |
| Dynamic | For a programmer to add a new code item in the |
| Value | Constant List at run time without updating the |
| | version of programs. An example is when the |
| | number of list items may change very often at run |
| | time, hence the values of the code are not known |
| | at design time and are assigned by the |
| | programmer at run time. There is only one Dynamic |
| | Value List, which is shared by other Status |
| | fields. |
| Value List | Specifies the storage location the dynamic values |
| Code | of the Constant List. |
| Edit List | Add - Add a new code item in the “Value List |
| Code | Code” list, and can be accomplished by activating |
| | the Add function, and filling in Code and Name |
| | fields, and activating the Update function. |
| | Change - Update an existing code item to the |
| | “Value List Code” list by activating the Change |
| | function, specifying the Code to be changed, |
| | changing the Name, and then activating the Update |
| | function. |
| | Delete - Delete an existing code item from the |
| | “Value List Code” list by activating the Delete |
| | function, specifying the Code to be deleted, and |
| | activating the Update function. |
| Reload When | Causes the compilable application program |
| Exit | generator 100 to reload the Status field when the |
| | cursor moves away from the fields defined here. |
| Access Key | For defining further requirement, particularly |
| | when the primary index is a composite key. For |
| | example, the Status field of stock table is |
| | composed of Company ID and Stock ID, and it is |
| | desired that the Stock IDs of the |
| | same company be displayed when loading this |
| | Status field. |

The reference data field tool 865S in FIG. 8L is used to retrieve information from another document, however, this data field is assigned after validation of the record and before the data is displayed on the screen. TABLE 10 lists some of the specification fields for the reference data field, and provides a description of the function of the specifications, as supported by the attributes of the reference data field tool 865S.

TABLE 10

| Specification | |
|---|---|
| Field | Description of Function |
| Read From | Identifies the document which contains the data that |
| Document | you want to read in. For example, Supplier Master. |
| Retrieve Data | The data field to get from the Read From Document, |
| Field | and then incorporate into the current document. |
| | From the above example, this can be the Supplier Name. |
| Through | There may be many available methods to read the ‘Read |
| Using Key | From Document’. Here the programmer can specify the |
| | method to find a desired record. |
| Define | Define parameters for reading a desired document. |
| | The parameter may be from the current record, |
| | from a system value or from calculation. Through the |
| | Definition buttons, the programmer can define how to |
| | assign these parameters. If the key that specified |
| | consists of more than one data field, than more than |
| | one entry must be defined. A maximum is 5 definitions |
| | is supported. |

In addition, the programmer can also specify reference data timing, which indicates when data is to be reloaded into the reference data fields.

The grid array field tool 865O in FIG. 8L is used to display data in a tabular format, and allow user's to edit the contents. Data can be loaded into the grid array in various ways as specified by the programmer from a variety of predetermined options. Alternatively, the programmer can control the loading of data using his own source code program via SLHs. The use of grid arrays may be grouped into four categories, namely, manual entry where a user enters data directly into a grid array; copy from other documents where data is copied from a grid array in another document; edit other document where data from a grid array of another document is edited; and merge, where data from more than one other grid array is merged and incorporated into the grid array of the present document.

In addition, extended attributes of the grid array tool 865O allows the programmer to also specify how the data is loaded into a grid array when specifying that data is to be copied from another document, or where data in another document is edited, or where data from other documents are merged.

TABLE 11 provides details of specification fields available to the programmer for specifying data entry into a grid array, as supported by the attributes of the grid array tool 865O.

TABLE 11

| Specification | |
|---|---|
| Field | Description of Function |
| Loading | The default is direct entry by the |
| Method | user, alternatively, loading from |
| | another document or using SLH, may |
| | be specified by the programmer. |
| | Other specification fields are |
| | applicable when the programmer |
| | chooses to load from a document. |
| From | The document that the grid is going |
| Document | to load data from. |
| Access Key | The access key that is going to be |
| | used. This access key will govern |
| | the mapping list and the sequence |
| | that data is displayed inside the |
| | grid. |
| Filter | The data that is going to be fed |
| Mapping | into the access key to locate the |
| | required data. If a filter field |
| | from the access key is not mapped, |
| | then a prompt screen will be |
| | displayed whenever the programmer |
| | chooses to load data into the grid. |
| Field | The data from the ‘from’ document, |
| Mapping | that is going to be displayed on |
| | the grid. If the field is left empty, |
| | then blank or zero will |
| | automatically be assigned. |
| Allow | Select between allowing a user to |
| Multiple | append data into the grid by |
| Copy | multiple selection of data from the |
| | ‘from’ document. |
| SLH | List of SLH logic that is available |
| | for the grid. The programmer can |
| | also initiate the Visual Basic |
| | editor, for example, to edit the |
| | source. But it should be noted that |
| | the trigger to use the SLH logic in |
| | the generated program is defined in |
| | the document details screen. |

Alternatively, the programmer can use SLHs, as defined using the logic option 839 of screen 837 in FIG. 8G. Further, when integrating an existing database or table into the current document, a link override option allows the programmer to set up the linking between the current grid array and the existing database or table. If the default link is selected then the compilable application program generator 100 establishes the link.

Returning now to FIG. 8L, the action button tool 865M is used to specific the operation of action buttons in the current document. TABLE 12 lists the various specifications and their respective functions for specifying an action button, as supported by the attributes of the action button tool 865M.

TABLE 12

| Specification | |
|---|---|
| Field | Description of Function |
| Button | There are two kinds of buttons available. |
| | System Buttons - These are buttons which are |
| | supported by the compilable application program |
| | generator 100, such as New, Cancel, Select, Save. |
| | Service Buttons - For the services defined in the flow |
| | diagram that will be described later. |
| Initiation | 0- Manual, this button needs to be manually activated |
| | by a user. |
| | 1 - Automatic, this button's action will be carried out |
| | automatically, after data has been saved. If the user |
| | activates manually, it will also be executed. |
| Button Type | Only Traditional Button is supported. |
| Save Before | Indicates that when the user activates the button, the |
| Execute | current content is saved to the database first. If yes, |
| | then validation will be done before saving the record. |

TABLE 13 below lists some system buttons that are available, depending on the type of program that is created.

TABLE 13

| Button Name | Description of Function |
|---|---|
| CNL | Cancel from current editing. If END |
| | button is not on the screen, then |
| | activating CNL again will terminate |
| | the program. |
| END | Terminate program. |
| NEW | Add a new record. |
| POS | The record slider allows the |
| | programmer to choose which record to |
| | edit from the records that fulfill |
| | the selection criteria. If there is |
| | only one record available, this |
| | button will not be displayed. |
| SLT | This button causes the selection |
| | screen to be displayed for the |
| | programmer to choose records to be |
| | edited. |
| SVE | Save the current record. |
| XC1-XC5 | Direct execution button. When any |
| | of these buttons is activated, a |
| | corresponding specific logic hook is |
| | activated. |

Again from FIG. 8L, the system function tool 865Q is used to display various data, which are automatically generated by the compilable application programmer generator 100. Such information includes system date, system time and aggregate information about data in a grid array. TABLE 14 lists the various specification fields and their respective functions for specifying system function information to be displayed, as supported by the attributes of the system function tool 865Q.

TABLE 14

| Specification | |
|---|---|
| Field | Description of Function |
| Function | This is a list of the functions that |
| Code | are supported by the compilable |
| | application program generator 100. |
| Work On | For some functions, particularly |
| Field | those aggregate functions, the |
| | programmer defines the data field |
| | that the aggregate function is to |
| | work on. |

After the documents used in a business operation have been created using the document creator 155, the process flowcharter 160 is then used to input the document process flow 120 of the documents. Again, as with the document creator 155, the process flow of each document is entered until the processes for all the documents is completed.

Typically for each document, at the end of process flow, the document is either stored or destroyed. For example, for a stock receipt transaction a stock receipt is created, filled, approved and then posted to the stock ledger before it can be destroyed or archived. The process flowcharter 160 describes the life cycle detailing the various stages that a particular document moves through. With this information, the compilable application program generator 100 can create and process the document by using services. Although, entering the process flow for the documents is not a compulsory requirement for all application program, it is recommended that a process flow or status flow, also referred to as work flow, is defined. The process flow advantageously allows the compilable application program generator 100 to check a defined process flow and control permitted actions at particular stages.

When entering a process flow of a particular document, the flowcharter 160 defines a status diagram; a service to change the status; and the logic of the service detailing what is going to be done.

When a created document is selected, and the command for process flow 809 in FIG. 8B selected, then a process flow definition screen 870 shown in FIG. 80 is presented to the programmer. The programmer adds and specifies services using the Service button 872, and adds and specifies status using the Status button 874. Services are represented by rectangles and status by computer icons. The rectangles 875, 876 and 877 represent an sEDT service, which represents the system default service for editing the current document; APV, for example, represents an approval service; and RTN represents a return service, respectively. The computer icons 878 and 879 represent Available status and Approved status, respectively. Editing of the current document is also controlled by status, and only documents specified as having an input status for sEDT can be edited.

A service is a process that acts on the current document, so as to change the status of the current document. For example, approving the current document changes its status from Available to Approved, or perhaps based on information contained in the current document, other documents are updated as a result of the service, as in posting information. A programmer defines a service by providing specifications for the service using attributes of that service.

Services such as approving, suspending and releasing of the current document changes its status, restricts editing of the current document, or limits subsequent actions, such as posting after approving the current document. These services are change status only services and are referred to as standard services. The compilable application program generator 100 supports the option of loging access to the information, such as who and when a service is carried out.

In addition, user defined services allow a programmer to specify the services, such as services that provide functions that are based on application know how. The attributes of user defined services are similar to standard services, however, in addition, the programmer can link segments of Visual Basic codes, for example, through SLHs that are developed by the programmer.

To define a service, for example the APV service 876, the programmer points to the service with his mouse and clicks on it. The service attributes screen 871, as shown in FIG. 8P is displayed. TABLE 15 below lists the various specification fields and their respective functions for specifying a service, as supported by the attributes of the service.

TABLE 15

| Specification Field | Description of Function |
|---|---|
| Service | The code assigned to the current |
| Code | service. Typically, a three |
| | character code is used. |
| Service | A description of the service. |
| Description | |
| Short Key | This is applicable when the current |
| | service is activated by a short cut |
| | key, and this specification assigns |
| | a short cut key to the current |
| | service. Typically, function keys Fl |
| | to F24 on the keyboard of a computer |
| | may be used for this purpose. |
| Change | Service can be grouped into two main |
| Status Only | categories, one is change status |
| | only, the other is using SLH. For |
| | example, suspending a document from |
| | further processing is normally a |
| | status change only service, while |
| | posting is a SLH service, which |
| | requires application logic and |
| | programming. |
| Edit Logic | Only applicable to SLH service. |
| | Activating this button invokes the |
| | Visual Basic editor, for example, |
| | for the programmer to write the |
| | application logic codes. |
| Input | The status of the document that the |
| Status | current service can apply to. |
| | If the document is at a status other |
| | than those specified, then the |
| | current service will not be started. |
| | If a user chooses such an action, |
| | an error message will be displayed |
| | automatically. |
| Output | The status that the document should |
| Status | be converted to, when the current |
| | service has been processed |
| | successfully. This will be done for |
| | both status change only service and |
| | SLH service. As a result, a |
| | programmer does not need to update |
| | the output status and the audit |
| | information for SLH service, but he |
| | only needs to set the return code |
| | correctly. |
| Security | The security key to protect the |
| Key | current service from illegal access. |
| Grouped | This is only applies to SLH service, |
| Service | and specifies whether all the |
| | records selected by the user will be |
| | processed at the same time, or the |
| | current service will be called |
| | several times, once for each record. |
| Audit | Specifies whether audit information, |
| Information | such as date, time, user etc., |
| | should be recorded and stored in the |
| | database whenever the current |
| | service is successfully executed. |
| | Relevant database fields will be |
| | created in the database |
| | layout, when the programmer chooses |
| | this option. |
| Manually | Specifies whether the current |
| Start | service can be used as a button on |
| | the screen. |
| Require | Determines whether confirmation |
| Confirmation | questions need to be displayed |
| | before proceeding. |
| Comment | Any comment text that describes the |
| | service and the logic. |

A status is a stage of the current document that needs to be designated, and provides a means for controlling the enabling or disabling of a field during editing. It also controls the service that is available under different conditions of the current document, and controls security by regulating who can access data at a particular stage.

To define a status, for example the Available status 878, the programmer points to the status with his mouse and clicks on it. The status attributes screen 890, as shown in FIG. 8Q is displayed. TABLE 16 below lists the various specification fields and their respective functions for specifying a status.

TABLE 16

| Specification | |
|---|---|
| Field | Description of Function |
| Status Code | An assigned code, typically single |
| | character. |
| Description | An short description of the purpose |
| | for this status. |
| Comment | Any text for description purpose. |

Returning again to FIG. 8B, activating the document access 807 selection on screen 801, allows the programmer to specify the expected sequence that data in the database is organized using access keys. This improves performance and the compilable application program generator 100 uses the expected sequence to check the data and the display the selection panel for code fields.

The programmer can define the access keys, which are used by the compilable application program generator 100 when generating source code, particularly when checking for unique constraints when inserting a record, automatically displaying the selection panel for code fields, and creating database definition language (DDL).

Upon selecting the documents access 807, a screen 892 is displayed, as shown in FIG. 8R, which allows the programmer to define access keys for the current document. TABLE 17 below lists the various specification fields and their respective functions for specifying an access key.

TABLE 17

| Specification Field | Description of Function |
|---|---|
| Key List | This is a list of the keys available |
| | for the current document. |
| Unique | Specifies whether this access key is |
| | a unique constraint. This can |
| | toggled between unique and not |
| | unique. |
| Key Name | Name of the key. When this |
| | specification field is filled and a |
| | New button activated, a new access |
| | key is created. |
| Description | The descriptive name for the access |
| | key. |
| Key Field | Selects which field exists in the |
| | access key. The order of the key |
| | will follow the sequence of the |
| | field defined. |
| List Of Value | This is the definition for the list |
| | panel to be displayed, if a code |
| | field is used, the current access |
| | key for validation. |
| Filter | The filtering field is available for |
| | the programmer to define the code |
| | field for data to be mapped to these |
| | filter fields, so that only minimum |
| | data is required to be entered by |
| | the programmer. |
| List Of Value | The data fields to be displayed for |
| | the programmer to view and select. |

There are instances when using the document creator 155 and the process flowcharter 160, for example, when input values are required, such as default values and input data to a code checking field. On occasion, the data is not from the database and some processing may be required to derive the required data. The compilable application program generator 100 provides a facility for the programmer to define functions that produce the required values. This facility is provided by a Define Function button when, for example, the programmer is entering specifications for attributes or extended attributes in a variety of screens.

When the Define Function button is activated, a define function screen 894, as shown in FIG. 8S, is displayed. TABLE 18 below lists the various specification fields and their respective functions for specifying a definite value. FIG. 8T shows screen 896 for specifying the value using predefined document functions, and FIG. 8U shows screen 898 for specifying the value from any defined tables.

TABLE 18

| | |
|---|---|
| Use Current Data | Use one of the data fields on the |
| | screen's current data. |
| Use System Value | Use one of the predefined system |
| | values, such as current date, time, |
| | workstation etc. |
| Use Constant Value | Use a manually keyed in constant |
| | value. |
| Use Specific Logic | Use SLH to supply this data. The |
| | programmer can activate the Edit |
| | button to enter the Visual Basic |
| | source code, for example. The |
| | Reference is the identifier to name |
| | this particular logic (SLH), since |
| | the same SLH can be shared by |
| | different functions. |
| Use Buffered Data | Use any one of the data buffered |
| | during the validation of the code |
| | field. |

After each document have been created with the document creator 155 and its processes entered using the flow charter 160, the compilable application program can be generated.

Referring once again to FIG. 8B, to generate the source code the program generation selection 813 is activated, and the compilable application program generator 100 generates the source code for the data processing program module 130 in Visual Basic, for example. After the data processing program module 130 has been created, it is optional to automatically compile the data processing source code program 130 into an executable or object code data processing program. There is an option to also automatically execute the database definition language module 140 to create a database for use with the data processing program module 130.

When the program generation selection 813 is activated, a generate source code screen 899, as shown in FIG. 8V, allows the programmer to select the documents from a list of the documents that were created earlier, based on which, source code programs and database definition language are to be generated. For different types of documents different types of programs will be generated.

For Header and Details type or Header only type documents, as selected in screen 835 in FIG. 8F when creating the documents, the compilable application program generator 100 creates two programs. One for the main program, which is also referred to as the edit program, and another is the list selection panel for selecting one or more records for processing. The inputs provided as generic attributes indicate the storage location at which the programs are stored.

For Request Form type documents, only one program is generated by the compilable application program generator 100, which is the source for producing the request form.

In a business operation, after inputting and processing data, there is the need to provide output information in various formats, such as reports, inquiry or extracts to a spreadsheet application. The report composer 165 defines the requirements of a report, and the report program generator 185 provides a report program module 140. The report program module 140 can then be compiled to produce an executable that generates the required report, as described earlier with reference to FIG. 5.

With reference to FIG. 8B, when the report composer selection 810 is activated, a Composer screen 900 is displayed, as shown in FIG. 8W, with a composer tool bar 901. The programmer uses the report composer to specify the requirements of a required report, and the specifications are entered by the programmer as a document, in a similar manner as the document creator 155. The composer tool bar 901 includes document commands for creating a new document 902, copying from an existing document 904, and deleting a document 906.

There is also a generate-document command 908 and an extended attributes command 910.

When the Create a new document command 902 is selected, a new document screen 912, as shown in FIG. 8X is displayed. The programmer can then enter information to identify the new document as a report, an inquiry or file extraction, using a document code. A document name can also be specified, however, the document name is used only for reference purposes.

After the new document is created, a Select Data screen 914, as shown in FIG. 8Y, is presented to the programmer. The programmer uses this screen 914 to select the data fields that will be used in the report, and the format of the data fields can be defined in two ways, i.e. by transferring from an existing data field or by manual definition. When transferring from an existing data field, the lower portion 916 of screen 914 is used. Activating the Add button 917 produces screen 920 as shown in FIG. 8Z, where the programmer can select any of the data fields from any of the documents that were previously created. TABLE 19 below lists the various specification fields and their respective functions for specifying a data field for transfer.

TABLE 19

| Specification Field | Description of Function |
|---|---|
| Operator | This option allows the programmer |
| | to determine whether the specified |
| | file is used to create the rows in |
| | a report, or for reference only |
| | where only data cells are filled |
| | in an existing cell in the report. |
| Document | Identifies any of the documents |
| | created by the document creator. |
| Access Key | When the operator is chosen to be a |
| | reference, then this specification |
| | field allows the programmer to |
| | choose the access key to be used to |
| | access the data in the reference |
| | file. This should be one of the |
| | unique keys defined for the |
| | reference table. |
| Add Criteria | Defines the relation in how to read |
| | the data from the file. For |
| | additions to a file, this is the |
| | filtering criteria in what records |
| | are to be added. Input values |
| | should be setup before this step. |
| | For a reference file type, this |
| | specification field provides the |
| | linking relationship between the |
| | report and the data file. |
| Data Map | Defines the relationship between |
| | the data field in the report and |
| | the data field in the data file. |

There is also a provision for the programmer to add criteria specifications as to how the data from the selected file is to be read, and also provisions to add data mapping specifications that define the relationship between the data filed in the selected document and the report that is to be generated.

Alternatively, the programmer can select the data field by manual definition. This is used when the required data is not from existing data fields but is created dynamically as required in accordance with the manual definition. When the programmer activates the Add button 922 on screen 914, an Add New Data Field screen 924 is presented, as shown in FIG. 8AA, and the programmer uses this screen to create a new data field that will appear in the Data Field list displayed on the upper portion 918 of the screen 914 in FIG. 8Y.

In addition, the programmer can choose to either use a reference or a direct definition to define the format of the new data field. With the direct definition the programmer enters the definition directly. However, to use a reference, the programmer selects an existing data field. Further, after creating a new data field, the programmer activates a Source button 926 on screen 914 in FIG. 8Y, and a Data Field Details screen 928 as shown in FIG. 8AB allows the programmer to define the data type.

When specifying a report, other specifications may be required and these are supported by activating the Setup button 930 on screen 914 of FIG. 8Y, which produces a Report Details screen 932, as shown in FIG. 8AC. Here the programmer can specify input values that a user provides when executing a report. In addition, the programmer can specify sorting sequences which the user will be allowed to select from for the report, and specify SLHs, when the SLHs are to be executed, and the scope of processing of the SLHs. There is also a provision to specify filtering options for the report as shown on screen 934 in FIG. 8AD.

In use the final executable report program provides three categories of output. These are reports, inquiry and export to file. For reports the programmer selects the report option 936 on the screen 932 in FIG. 8AC. TABLE 20 below lists the specification field and the respective functions for specifying an output software application that generates the report.

TABLE 20

| | |
|---|---|
| Output Software | In a preferred embodiment the output software |
| | Crystal Report is identified, and activating the |
| | Layout button the Crystal Report editor screen |
| | will be displayed. The data is stored in a |
| | Microsoft Access database with two tables |
| | containing the data and the input values. |
| | A programmer can use the two tables to create a |
| | layout for the report. |

For extraction to a file, the programmer selects the file option 938 on the screen 932 in FIG. 8AC. TABLE 21 below lists the specifications and their respective functions for specifying output file details.

TABLE 21

| | |
|---|---|
| File Type | Specifies the type of extracted file to be created. For |
| | example, a tab-delimited file can be read by a |
| | spreadsheet application such as Microsoft's Excel, and a |
| | number of utility programs. |
| File Name | Default will be equal to the report document code. |
| Path | The directory at which the extracted file is stored. |
| Output with | Specifies whether an additional line of heading is |
| Heading | created as the first line in the output file. |

Finally, for an inquiry, the programmer selects the inquiry option 940 on the screen 932 in FIG. 8AC, and an Available Fields screen 942 and a Canvas screen 944 are displayed, as shown in FIG. 8AE. The programmer designs the inquiry using the commands 946 on the Available Fields screen 942 in FIG. 8AE, and the resultant inquiry design is presented in the Canvas screen 944.

The present invention, as described, provides a compilable application program generator that uses documents and document processes of a business operation to generate a compilable application program that includes a data processing program module, a report program module, a database definition language module, and manuals. The compilable application program is then used to produce an executable data processing program, a report program, and a database, which support the documents and document processes of the business operation.

This is accomplished by a compilable application program generator that comprises a document creator for recreating the documents from document specifications, and a document process flowcharted for modeling the process flow of the document in the operation of the business using document process flow specifications. In addition, a report composer allows a programmer to create the reports that are required in the operation of the business with report specifications, so that a report program generator produces a report program module, which provides an executable report program that produces required reports. In addition, a manual generator produces manuals for the compilable application program in accordance with inputs to a manual selector.

Thus, the present invention, as described, provides a method and apparatus for generating compilable application programs, which overcomes or at least reduces the abovementioned problems of the prior art.

It will be appreciated that although only one particular embodiment of the invention has been described in detail, various modifications and improvements can be made by a person skilled in the art without departing from the scope of the present invention.

I claim:

1. A compilable application program generator for generating a compilable application program for a business operation, and wherein the business operation utilizes a plurality of documents, wherein the compilable application program generator comprises:
a graphical user interface comprising a document creator for receiving document specifications of each of the plurality of documents and for providing document definitions;
a memory coupled to the graphical user interface for storing the document definitions, and for storing a plurality of compilable program templates; and
a data processing program generator coupled to the memory, the data processing program generator for retrieving a reference data processing compilable program template from the memory, for accessing the document definitions, for selectively retrieving at least some of the plurality of compilable program templates from the memory in accordance with the document definitions, and for incorporating the at least some of the plurality of compilable program templates into the reference data processing compilable program template to produce a compilable data processing program module.

2. A compilable application program generator in accordance with claim 1 wherein the each of the plurality of documents has predetermined processes associated therewith in the operation of the business,
wherein the graphical user interface further comprises a process flowcharter for receiving process specifications of the predetermined processes associated with the each of the plurality of documents, and for providing process definitions;
wherein the memory is adapted for storing the process definitions, and for storing another plurality of compilable program templates; and
wherein the data processing program generator adapted for accessing the process definitions, for selectively retrieving at least some of the another plurality of compilable program templates in accordance with the process definitions, and for incorporating the at least another plurality of compilable program templates into the reference data processing compilable program template to produce another compilable data processing program module.

3. A compilable application program generator in accordance with claim 1 wherein the business operation uses a plurality of reports,
wherein the graphical user interface further comprises a report composer for receiving report specifications of each of the plurality of reports, and for providing report definitions;
wherein the memory is adapted for storing the report definitions, and for storing a further plurality of compilable program templates; and
wherein the compilable application program generator comprises a report program generator for accessing the report definitions, for selectively retrieving at least some of the further plurality of compilable program templates in accordance with the report definitions, and for incorporating the at least some of the further plurality of compilable program templates into a reference report compilable program template to produce a compilable report program module.

4. A compilable application program generator in accordance with claim 2,
wherein the document specifications and the process specifications comprise description specifications, and wherein the document creator and the process flowcharter receive the description specifications associated with each of the plurality of documents and each of the plurality of processes, and the document creator and the process flowcharter for providing description definitions;
wherein the memory is adapted for storing the description definitions; and
wherein the compilable application program generator comprises a manual generator coupled to the memory, the manual generator for accessing the description definitions, for generating at least one manual using the description definitions, and for providing the at least one manual.

5. A compilable application program generator in accordance with claim 4 wherein the graphical user interface further comprises a manual selector for receiving input indicating the at least one manual is to be generated.

6. A compilable application program generator in accordance with claim 1 wherein the document creator comprises document layout tools for including a plurality of data items for each of the plurality of documents.

7. A compilable application program generator in accordance with claim 6 wherein the plurality of data items comprise various combinations of data fields, labels information, and action buttons.

8. A compilable application program generator in accordance with claim 7 wherein each of the plurality of data items includes a variety of data attributes associated therewith.

9. A compilable application program generator in accordance with claim 2 where the process flowcharter comprises a service specifier for receiving the process specifications of the predetermined processes associated, with the each of the plurality of documents, and for providing service definitions.

10. A compilable application program generator in accordance with claim 2 where the process flowcharter comprises a status specifier for receiving the process specifications of the predetermined processes associated with the each of the plurality of documents, and for providing status definitions.

11. A method for generating a compilable application program for a business operation, and wherein the business operation utilizes a plurality of documents, the method comprising the steps of:
b) receiving user specifications for each of the plurality of documents;
b) processing the user specifications to produce a plurality of definitions; and
c) using predetermined data processing definitions of the plurality of definitions and at least a first plurality of compilable program templates to generate a compilable data processing program module.

12. A method for generating a compilable application program in accordance with claim 11 further comprising the step (d) of using the compilable data processing program module to produce an executable data processing program module, wherein upon execution the executable data processing program module reproduces the each of the plurality of documents.

13. A method for generating a compilable application program in accordance with claim 11 wherein step (a) comprises the step of receiving document specifications, and wherein step (b) comprises the step of processing the document specifications to produce document definitions, wherein the document definitions comprise at least at least a first plurality of the predetermined data processing definitions.

14. A method for generating a compilable application program in accordance with claim 13 wherein step (c) comprises the step of using the document definitions and the at least the first plurality of compilable program templates to generate the compilable data processing program module.

15. A method for generating a compilable application program in accordance with claim 13 wherein step (a) further comprises the step of receiving process specifications for predetermined processes associated with the each of the plurality of documents, and wherein step (b) further comprises the step of processing the process specifications to produce process definitions, wherein the process definitions comprise at least a second plurality of the predetermined data processing definitions.

16. A method for generating a compilable application program in accordance with claim 15 wherein step (c) further comprises the step of using the process definitions and at least a second plurality of the compilable program templates to generate another compilable data processing program module.

17. A method for generating a compilable application program in accordance with claim 16 further comprising the step of using the another compilable data processing program module to produce another executable data processing program module, wherein upon execution the another executable data processing program module reproduces the each of the plurality of documents, and the another executable data processing program module processes the each of the plurality of documents in accordance with the predetermined processes associated with the each of the plurality of documents.

18. A method for generating a compilable application program in accordance with claim 12 further comprising step (e) of using predetermined database definitions of the plurality of definitions to generate a database definition language module.

19. A method for generating a compilable application program in accordance with claim 18 further comprising step (f) of using database definition language module to generate a database for operating with the executable data processing program module.

20. A method for generating a compilable application program in accordance with claim 11 wherein step (a) further comprises the step of receiving report specifications for each of a plurality of reports, and where step (b) further comprises the step of processing the report specifications to produce report definitions of the plurality of definitions, and wherein step (c) comprises the step of using the report definitions of the plurality of definitions and at least a third plurality of compilable program templates to generate a compilable report program module.

21. A method for generating a compilable application program in accordance with claim 20 wherein step (d) further comprises the step of using the compilable report program module to produce an executable report program module, wherein upon execution the executable report program module reproduces the each of the plurality of the reports.

22. A method for generating a compilable application program in accordance with claim 15 wherein step (b) further comprises the step of processing the document specifications and the process definitions to produce manual definitions of the plurality of definitions, and wherein step (c) comprises the step of using the manual definitions of the plurality of definitions to generate manuals.

23. A method for generating a compilable application program in accordance with claim 12 further comprising the step (g) of testing operation of the executable data processing program module in accordance with predetermined data processing program module tests.

24. A method for generating a compilable application program in accordance with claim 23 further comprising the step (h) of amending the document specifications when the executable data processing program module does not pass the testing, and repeating steps (a) to (d), and step (g).

25. A compilable report program generator for generating a compilable report program, wherein the compilable report program generator comprises:
a graphical user interface comprising a report composer for receiving report specifications of each of the plurality of reports and for providing report definitions;
a memory coupled to the graphical user interface for storing the report definitions, and for storing a plurality of compilable program templates; and
a report program generator coupled to the memory, the report program generator for retrieving a reference report compilable program template from the memory, for accessing the report definitions, for selectively retrieving at least some of the plurality of compilable program templates from the memory in accordance with the report definitions, and for incorporating the at least some of the plurality of compilable program templates into the reference report compilable program template to produce the compilable report program.

26. A compilable report program generator in accordance with claim 25 wherein the report composer is coupled to a database of a data processing program, and wherein the report composer comprises data selection tools for selecting a plurality of data items from the database that is to be included in at least one of the each of the plurality of reports.

27. A compilable report program generator in accordance with claim 26 wherein the plurality of data items comprise a variety of data fields.

28. A compilable report program generator in accordance with claim 25 wherein the report composer further comprises a data specifier for specifying a further plurality of data items that is to be included in at least one of the each of the plurality of reports.

29. A method for generating a compilable report program, the method comprising the steps of:
a) receiving report specifications for each of a plurality of reports;
b) processing the report specifications to produce a plurality of report definitions; and
c) using the plurality of report definitions and at least a first plurality of compilable program templates to generate the compilable report program.

30. A method for generating a compilable application program in accordance with claim 29 further comprising the step (d) of using the compilable report program to produce an executable report program, wherein upon execution the executable report program produces the each of the plurality of reports.
